(19) United States
(12) Patent Application Publication
(10) Pub. No.: US 2022/0379501 A1
(43) Pub. Date: Dec. 1, 2022

(54) BLADE FOR A DRYWALL KNIFE

(71) Applicant: Vincent Leon GILES, Stoney Creek (CA)

(72) Inventor: Vincent Leon GILES, Stoney Creek (CA)

(21) Appl. No.: 17/886,913

(22) Filed: Aug. 12, 2022

Related U.S. Application Data
(62) Division of application No. 16/784,303, filed on Feb. 7, 2020, now Pat. No. 11,433,560.

(51) Int. Cl. B26B 1/10; B26B 1/08

(52) U.S. Cl. CPC B26B 1/10; B26B 1/08

(57) ABSTRACT

A utility knife, a blade member for use therewith, and a method of using the same; The knife has an ergonomically designed, symmetrical handle with resilient grips for a user's palm and fingers provided on opposing top and bottom walls of the housing. The blade member has two opposed cutting surfaces aligned with the housings top and bottom walls. A tape engagement clip is provided on a leading end of the knife and secures a free end of a measuring tape to the knife. The knife may be gripped and used in two different orientations located 180 degrees apart. The tape engagement clip pivots to enable the free end of the measuring tape to be secured to the knife regardless of which cutting surface is used to cut an article. Alternatively, the clip may be moved to the opposing side wall of the knife.

### CROSS-REFERENCE TO RELATED APPLICATIONS

This application is a Divisional of U.S. patent application Ser. No. 16/784,303, filed Feb. 7, 2020, the entire disclosure of which is incorporated herein by reference.

### TECHNICAL FIELD

This disclosure is directed to hand-held cutting tools. More particularly, this disclosure is directed a utility knife. Specifically, the disclosure relates to a utility knife with an ergonomically designed handle having resilient grips for a user's palm and fingers and configured to hold a blade member with two opposed cutting surfaces. A tape engagement clip is provided on a leading end of the knife and is arranged to secure a free end of a measuring tape to the knife. The knife may be gripped and used in two different orientations that are located 180 degrees apart. The tape engagement clip is able to pivot to enable the free end of the measuring tape to be secured to the knife regardless of which cutting surface is being used to cut an article.

### BACKGROUND

### Background Information

Utility knives are used for a variety of different uses. Utility knives may use fixed, folding, retractable, or replaceable blades and tend to come in a wide variety of lengths and styles suited to the particular set of tasks they are designed to perform. Presently known utility knives tend to fall into one of three categories. A first category is a foldable knife in which a single blade is pivotally engaged with a handle. The blade is pivoted between a use position and a folded position. In the use position, the blade extends forwardly from a front end of the handle and is able to be used to cut an object. When in the folded position, the blade is moved into a position where it lays in abutting contact with at least a part of the handle. In this folded position, the blade can no longer be used for cutting objects. These types of utility knives are useful for only a narrow range of tasks and have to be handled carefully as the person needs to grasp the blade to move it between the use position and the folded position. These types of knives may be suitable for use as camping or outdoor knives or as box cutters.

A second category of utility knife is a fixed-blade knife. Knives in this category have a handle with a blade extending outwardly and forwardly therefrom. The blade cannot be retracted or pivoted relative to the handle. Fixed-blade knives may be used for crafts and various hobbies. In other instances, the blade may be quite substantial and can be used as a hunting knife, for example. In these instances, the blade will typically be selectively coverable with some type of sheath when the knife is not in use. The sheath will help to prevent the cutting surface of the blade from being accidentally contacted and will thereby protect the person from accidental cuts. The sheath may also help to prevent the blade from coming into contact with objects that might damage the cutting surface.

A third category of utility knife is a retractable knife. In these knives, the blade is mounted on some type of sliding mechanism that allows a person to move the blade between a use position and a storage position. In the use position, at least a leading end of the blade projects forwardly from the handle. In the storage position, substantially the entire blade is moved into a cavity defined within the handle. The person is able to select the degree to which the blade is moved outwardly from the handle or inwardly into the handle. This type of knife is commonly used in the construction industry for performing tasks such as cutting sheets of drywall. Utility knives used in the construction industry tend to fall into three groups that have retractable and replaceable blades made of die-cast metal.

A first group of this third category of utility knife have blades that comprise an elongated strip made up of a plurality of segments which are separated from each other by lines of weakness. A plurality of these angled lines of weakness is provided at intervals along the strip. A bottom edge of the strip is sharpened and comprises a cutting surface of the blade. At least the first segment of the strip can be extended outwardly from a front end of the knife handle. The rest of the strip remains within the interior of the handle. The leading end of the strip, i.e., the first segment thereof, presents a first portion of the cutting surface and can be used to cut objects. When the cutting surface on the first segment becomes dull, the person is able to snap the first segment of the strip from the rest of the strip. A second segment of the strip then become a new leading end that may be extended outwardly from the handle. The second segment also include a second portion of the sharp cutting surface of the strip and can therefore be used to cut objects. When the cutting surface on the second segment becomes dulled, that second segment is snapped off the rest of strip and a third segment of the strip become the leading end, and so on. A plurality of these blade strips may be stored in the knife handle or the handle may be opened to reload a new strip when the original strip has been used up and discarded.

A second group of the third category of utility knives have blades that are generally trapezoidal in shape. The blades has a bottom edge that is sharpened into a cutting surface. The blades present a first angled end that extends in a first direction and a second angled end that extends in a second direction. The knife handle may be opened and one of these blades may be engaged with a sliding mechanism. When the blade is engaged, the handle is closed around the blade and the sliding mechanism may be operative to extend one of the first angled end and the second angled end outwardly from the handle housing. When the cutting surface on the first angled end or the second angled end becomes dull, the person will open the handle to gain access to the interior, will disengage the blade from the sliding mechanism, and will rotate the blade through 180 degrees. The blade will be reengaged with the sliding mechanism and the handle will be closed up again. The person may then operative the sliding mechanism to extend the other of the first and second angled ends outwardly from the housing. When the cutting surface on the other of the first and second angled ends becomes dull, the person will open up the handle, disengage the blade from the sliding mechanism, and then discard the blade. A new blade (which may be stored in the handle) is then engaged with the sliding mechanism, the handle is closed up again, and the utility knife may be used as previously described.

The knives of either of these two groups discussed above allow the person to adjust how far the blade extends outwardly from the handle so that the knife can safely be used for selected purposes. The knives can be used for tasks such as cutting tape sealing a package, cutting open sealed plastic packaging, or cutting drywall. As discussed above, if the blade becomes dull it can be quickly reversed or switched for a replacement blade. Spare or used blades may be stored in the hollow handle of some models and can be readily accessed if needed. Other knife models have a quick-change mechanism that allows the blades to be replaced without the use of additional tools. Specialized knives also exist for cutting string, linoleum, and other materials.

A third group of the third category of utility knives includes a simple sleeve that is provided around a rectangular handle and into which a single-edge utility blade may be inserted. The sleeve slides up or down on the handle, holding the blade in place during use and covering the blade when it is not in use. The blade holder may retract or fold into the handle, much like a folding-blade pocketknife. The blade holder is designed to expose just enough cutting surface as to enable the knife to cut through a single layer of corrugated fiberboard, for example, so as to minimize the chances of damaging the contents inside a cardboard box.

As indicated earlier herein, one of the tasks for which utility knives are used is cutting drywall sheets. Do-it-yourself enthusiasts may use a tape measure, pencil, and square or ruler to mark a line along the surface of a sheet of drywall. They will then extend a blade outwardly from the handle of one of the types of utility knife described herein and will use the blade thereof to cut the sheet of drywall. In some instances, they will also use a ruler or set square as a cutting guide to help keep them moving the blade along the marked line.

This is not how drywall professionals tend to cut drywall sheets. Professional drywall installers usually hold a utility knife in one hand and the end of a measuring tape is hooked over the thumb on the hand that is holding the knife. With the other hand they lock the tape at the correct distance and hook and slide the tape across the edge of the drywall sheet while simultaneously cutting the drywall. While this, at first glance, would seem to be a relatively simply operation, it takes years of practice to perfect the technique and cut drywall sheets at the desired location and to the correct size.

### SUMMARY

A utility knife, a blade member for use therewith, and a method of using the same; The knife has an ergonomically designed, symmetrical handle with resilient grips for a user's palm and fingers provided on opposing top and bottom walls of the housing. The blade member has two opposed cutting surfaces aligned with the housings top and bottom walls. A tape engagement clip is provided on a leading end of the knife and secures a free end of a measuring tape to the knife. The knife may be gripped and used in two different orientations located 180 degrees apart. The tape engagement clip pivots to enable the free end of the measuring tape to be secured to the knife regardless of which cutting surface is used to cut an article. Alternatively, the clip may be moved to the opposing side wall of the knife.

The present disclosure is directed to a retractable, replaceable blade which has a unique shape that increases the cutting life of the blade. The blade is a snap-off style blade with two edges and a dedicated shape. The disclosure is also directed to a utility knife that is configured to receive the disclosed blades. The disclosure is further directed to a utility knife that is particularly useful for tasks such as cutting drywall. The utility knife in accordance with the present disclosure includes a tape engagement mechanism that enables a person to lock an end of a tape from a measuring tape with the knife. The tape engagement mechanism includes a swivel that helps to eliminate misalignment between the tape and knife. The knife also has rubber grips on its ergonomically designed handle and be used by both left handed and right handed persons.

In one aspect, an exemplary embodiment of the present disclosure may provide a utility knife comprising a housing having a first end and a second end, and a longitudinal axis extending therebetween; said housing defining an interior cavity that is accessible through an opening defined in the first end; a blade member received in the interior cavity and being selectively movable relative to the first end between a retracted position and an extended position; and when in the extended position, a portion of the blade member extends outwardly through the opening and beyond the first end; and a first side wall and a second side wall that each extend from the first end to the second end, and have a midline that is parallel to the longitudinal axis, and wherein the first side wall and the second side wall are substantially symmetrical about the midline. In an exemplary embodiment, the housing may further include a top wall and an opposed bottom wall that extend between the first side wall and the second side wall from the first end to the second end, and wherein the top wall and the bottom wall are substantially identical to each other and are arranged as mirror images of each other. In an exemplary embodiment, each of the top wall and the bottom wall may define a projection that extends outwardly for a greater distance from the midline than a rest of the top wall and the bottom wall, respectively, and wherein each projection includes a downwardly angled surface that extends from an apex of the projection towards the first end of the housing; and wherein the downwardly angled surface is adapted to selectively receive a thumb pad of a user of the utility knife thereon. In an exemplary embodiment a first overmold may be provided on the top wall; and a second overmold may be provided on the bottom wall; and each of the first overmold and the second overmold may comprise a resilient material. In an exemplary embodiment each of the first overmold and the second overmold may have alternating ribs and spaces, wherein the ribs are of varying heights and are arranged as a series of undulating hills and valleys.

In another aspect, an exemplary embodiment may further comprise a tape engaging clip provided on one of the first side wall and the second side wall of the housing wherein the tape engaging clip defines a passage therein, and wherein the passage is adapted to selectively receive a portion of a free end of a measuring tape therein. In an exemplary embodiment, the tape engaging clip may be selectively rotatable about an axis that is oriented at right angles to the longitudinal axis of the housing.

In another aspect, the blade member utilized with the utility knife may have a first edge and a second edge that are aligned with the top wall and the bottom wall of the housing, respectively, and at least a portion of each of the first edge and the second edge is sharpened to form a cutting surface. In an exemplary embodiment, the blade member may have a first end and an opposed second end that extend between the first edge and the second edge; and the blade member has a midline that is substantially equidistant from the first edge and the second edge; and the blade member is symmetrical about the blade member's midline. In an exemplary embodiment, the first end of the blade member may include a first tip proximate an intersection of the first end and the first edge and a second tip at an intersection of the first end and the second edge, and wherein the first tip and second tip are substantially identical in shape. In an exemplary embodiment, the first tip and the second tip may each be an inverted V-shape and extend outwardly from blade member in generally the same direction. In an exemplary embodiment, the first tip and the second tip may be substantially J-shaped, and the first tip and the second tip may be arranged on the blade member as mirror images of each other.

In another aspect, an exemplary embodiment of the present disclosure may provide a blade member for a utility knife comprising a planar member having a first end and a second end opposed to the first end; a first edge and a second edge opposed to the first edge; wherein the first edge and the second edge extend between the first end and the second end; and a first side and a second side opposed to the first side; wherein the first side and the second side extend between the first edge and the second edge; wherein at least a portion of the first edge is sharpened into a first cutting surface; and wherein at least a portion of the second edge is sharpened into a second cutting surface.

In an exemplary embodiment each of the first side and second side of the planar member may have a midline that is generally equidistant from the first edge and the second edge, and the planar may be is substantially symmetrical about the midline. In one exemplary embodiment one or more lines of weakness may be defined in the first side and the second side of the planar member and may extend between the first cutting surface and the second cutting surface, wherein each of the one or more lines of weakness may be substantially identical in shape to the first end of the planar member. In an exemplary embodiment the planar member may include a first tip defined proximate an intersection of the first end and the first edge and a second tip defined proximate an intersection of the first end and the second edge. In an exemplary embodiment, the first tip and the second tip may be identical in shape and extend generally in the same direction. In an exemplary embodiment, the first tip and the second tip may be identical in shape and arranged as mirror images of each other.

In another aspect, and exemplary embodiment of the present disclosure may provide a method of cutting a drywall sheet comprising moving a blade member longitudinally along a longitudinal axis of a utility knife housing from a retracted position to an extended position; providing a first cutting surface and a second cutting surface along opposed first and second edges of the blade member; gripping the utility knife housing in either of a first orientation or a second orientation in either of a user's left hand or right hand of the user; cutting the drywall sheet with the first cutting surface when the utility knife housing is held in the first orientation and cutting the drywall sheet with the second cutting surface when the utility knife housing is held in the second orientation, where the first orientation and second orientation are 180 degrees apart from each other.

In an exemplary embodiment the method may further comprise securing a free end of a measuring tape to a tape engagement clip provided on a leading end of the utility knife housing. The method may further comprise extending a length of the measuring tape outwardly from a measuring tape housing and holding the measuring tape housing a distance outwardly from the utility knife and adjacent a surface of an article, and cutting the article with one of the first cutting surface or the second cutting surface. In an exemplary embodiment the method may include pivoting the tape engagement clip through 180 degrees when the utility knife housing is moved from the first orientation to the second orientation. In an exemplary embodiment, the securing may be temporary. In one embodiment the method may include engaging the tape engaging clip with one of a first side wall and a second side wall of the leading end of the utility knife housing and moving the tape engaging clip to the other of the first side wall and the second side wall prior to moving the utility knife housing from the first orientation to the second orientation and vice versa. In one embodiment the securing may include inserting a vertical leg of the free end of the measuring tape into a passage defined in the tape engaging clip.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top, front, left side, perspective view of a utility knife in accordance with an aspect of the present disclosure;

FIG. 2 is a bottom, front, left side, perspective view of the utility knife of FIG. 1;

FIG. 3A is an exploded top, front, left side, perspective view of the utility knife of FIGS. 1 and 2;

FIG. 3B is an exploded bottom, back, right side, perspective view of the utility knife of FIGS. 1 and 2;

FIG. 4 is left side elevation view of the knife;

FIG. 5 is a longitudinal cross-section of the utility knife taken along line 5-5 of FIG. 4;

FIG. 6 is a transverse cross-section of the utility knife taken along line 6-6 of FIG. 4;

FIG. 7 is a transverse cross-section of the utility knife taken along line 7-7 of FIG. 4;

FIG. 8 is a right side elevation view of the utility knife

FIG. 9 is a front elevation view of the utility knife shown in FIG. 8;

FIG. 10 is a rear elevation view of the utility knife shown in FIG. 8;

FIG. 11 is a top plan view of the utility knife;

FIG. 12 is a bottom plan view of the utility knife;

FIG. 13 is a left side elevation view of the utility knife showing the rotatability of the tape engagement clip;

FIG. 14 is a left side elevation view showing the knife of FIG. 1 gripped in a person's right hand;

FIG. 15 is a top, front, left side, perspective view of the utility knife showing a measuring tape engaged with the tape engagement clip when the tape engagement clip is located on the second side wall of the second housing section;

FIG. 16 is a top plan view of the utility knife and measuring tape shown in FIG. 15;

FIG. 17 is a top, front, right side, perspective view of the utility knife showing the tape measuring assembly engaged with the first side wall of the second housing section;

FIG. 18 is a top, front, right side, perspective view of the utility knife of FIG. 17 showing a measuring tape engaged with the tape engagement clip;

FIG. 19 is a right side elevation view showing the rotatability of the tape engagement clip located on the utility knife shown in FIG. 17;

FIG. 20A is a left side elevation view of the first embodiment of a blade member in accordance with the present disclosure shown on its own;

FIG. 20B is a left side view of the first embodiment of the blade member showing a dulled blade segment broken off therefrom;

FIG. 21A is a front elevation view of a first side of a second embodiment of a blade member in accordance with the present disclosure shown on its own;

FIG. 21B is a front elevation view of a second side of the second embodiment of the blade member showing a dulled segment blade broken off therefrom;

FIG. 22 is a top, front, left side, perspective view of a second embodiment of utility knife in accordance with an aspect of the present disclosure shown engaged with a second embodiment of a tape engagement clip;

FIG. 23 is a top, front, left side, perspective view of the knife of FIG. 23 engaged with a measuring tape;

FIG. 24 is a left side elevation view of the knife of FIG. 23;

FIG. 25 is a top, front, right side, perspective view of the second embodiment of utility knife shown engaged with the second embodiment of the tape engagement clip;

FIG. 26 is a top, front, right side, perspective view of the knife of FIG. 25 engaged with a measuring tape;

FIG. 27 is a right side elevation view of the knife of FIG. 25;

FIG. 28 is a top, front, left side, perspective view of a third embodiment of utility knife in accordance with an aspect of the present disclosure shown engaged with a third embodiment of a tape engagement clip;

FIG. 29 is a cross-section of the utility knife and tape engagement clip taken along line 29-29 of FIG. 28;

FIG. 30 is a top, front, left side, perspective view of the utility knife of FIG. 1 shown engaged with a fourth embodiment of a tape engagement clip in accordance with an aspect of the present disclosure;

FIG. 31 is a top, front, left side, perspective view of the fourth embodiment tape engagement clip shown in FIG. 30;

FIG. 32 is a top, rear, right side, perspective view of the tape engagement clip of FIG. 30;

FIG. 33 is a front elevation view of the tape engagement clip of FIG. 30;

FIG. 34 is a left side elevation view of the tape engagement clip of FIG. 30;

FIG. 35 is a cross-section of the utility knife and tape engagement clip taken along line 35-35 of FIG. 30;

FIG. 36 is a top, front, left side, perspective view of the utility knife of FIG. 1 shown engaged with a fifth embodiment of a tape engagement clip in accordance with an aspect of the present disclosure;

FIG. 37 is a top, front, left side, perspective view of the fifth embodiment tape engagement clip shown in FIG. 36;

FIG. 38 is a top, rear, right side, perspective view of the tape engagement clip of FIG. 36;

FIG. 39 is a front elevation view of the tape engagement clip of FIG. 36;

FIG. 40 is a left side elevation view of the tape engagement clip of FIG. 36; and

FIG. 41 is a cross-section of the utility knife and tape engagement clip taken along line 41-41 of FIG. 36.

Similar numbers refer to similar parts throughout the drawings.

### DETAILED DESCRIPTION

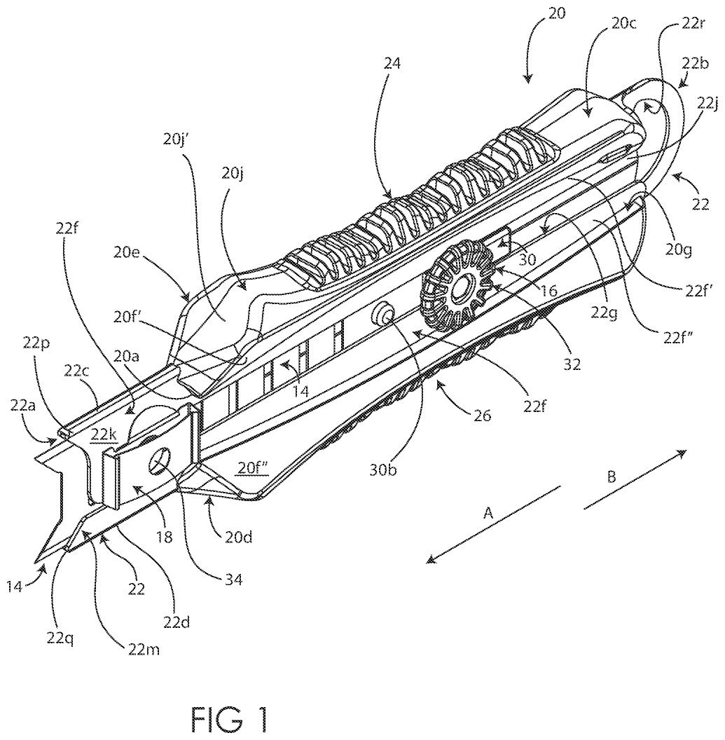

Referring to FIGS. 1-41, there is shown a utility knife in accordance with the present disclosure, generally indicated by the reference number 10. Knife 10 may be utilized for a wide variety of different uses, where those uses are similar to how previously-known utility knives have been used. In particular, knife 10 is contemplated as being advantageously suitable for cutting sheets of drywall. More specifically, knife 10 is contemplated as being particularly suitable for simultaneously measuring and cutting drywall sheets. The various component parts of knife 10 and the use of knife 10 will be described hereafter in greater detail.

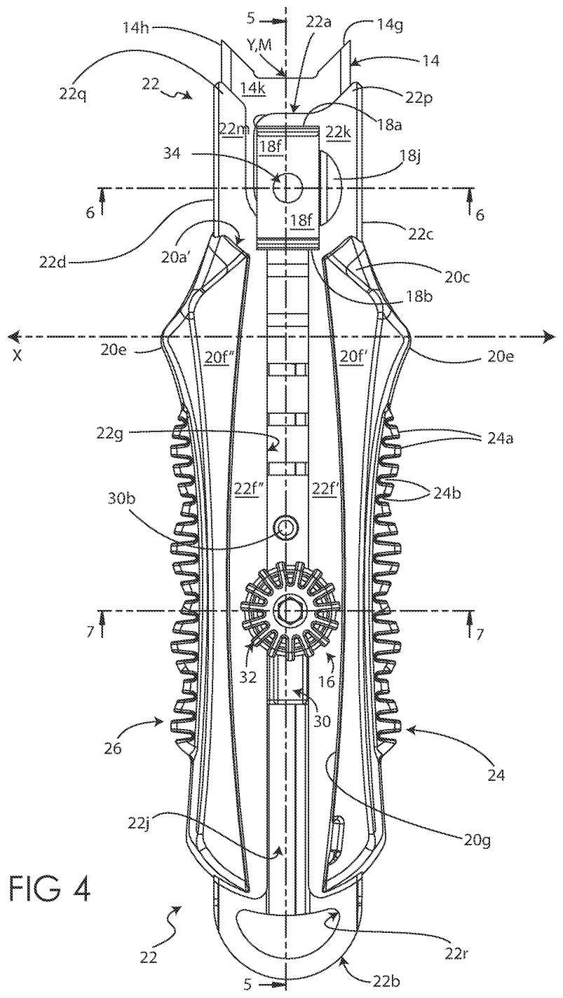

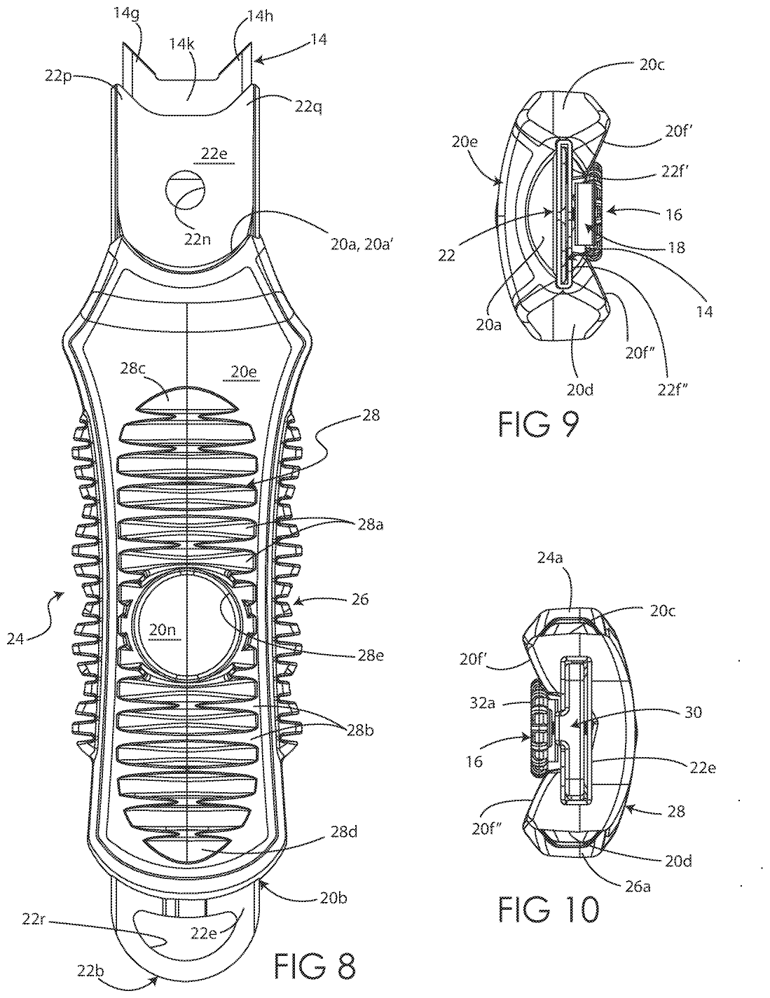

Referring to FIGS. 1-12, knife 10 comprises a housing 12, a blade member 14, a locking mechanism 16, and a tape engagement clip 18. The blade member 14 that is shown in these figures is a first embodiment of a blade member that may be utilized with knife 10. Later in this disclosure, at least a second embodiment of a blade member will be described for use with knife 10. Similarly, the tape engagement clip 18 that is shown in FIGS. 1-12 is a first embodiment of a tape engagement clip that is able to form part of knife 10. Later in this disclosure, at least a second embodiment of a tape engagement clip will be described as being able to form a part of knife 10. Knife 10 has a first end 10a and a second end 10b and a longitudinal axis “Y” (FIGS. 4 and 8) extending between first end 10a and second end 10b. First end 10a comprises a front end of the knife 10, meaning that it is the end of the knife 10 from which a leading end of blade member 14 may be caused to extend in order to perform a cutting operation. Second end 10b comprises a rear end of the knife 10.

In accordance with an aspect of the present disclosure, housing 12 comprises a first housing section 20 and a second housing section 22. First and second housing sections 20, 22 are complementary with each other and are configured to be interlockingly engaged together. When interlockingly engaged, first and second housing sections 20, 22 together form an ergonomic shape that makes housing easy and comfortable for a person to hold and manipulate.

First and second housing sections 20, 22 are fabricated from any suitable material in any suitable manner. For example, one or both of first and second housing sections 20, 22 may be molded from plastic or die-cast from metal or may be partially fabricated from metal and partially fabricated from plastic. It will be understood, however, that any suitable materials may be selected to fabricate housing 12.

First housing section 20 is an integrally-formed component which has a first end 20a, a second end 20b, a top wall 20c, a bottom wall 20d, a first side wall 20e, and a second side wall 20f. First end 20a and second end 20b are opposed to each other and define a longitudinal direction therebetween. Top wall 20c and bottom wall 20d are opposed to each other and define a vertical direction therebetween. First side wall 20e and second side wall 20f are opposed to each other and define a lateral or transverse direction therebetween. First side wall 20e has a midline “M” (FIG. 8) which extends from first end 20a to second end 20b and is generally parallel to longitudinal axis “Y”. Second housing 20 is substantially symmetrical about midline “M” as is best seen in FIG. 8.

A longitudinally-extending slot 20g is defined by second side wall 20f. Slot 20g extends from first end 20a to second end 20b and divides second side wall 20f into an upper wall section 20f′ and a lower wall section 20f. Slot 20g extends substantially parallel to midline “M”. Upper wall section 20f′ is integral with top wall 20c and lower wall section 20f″ is integral with bottom wall 20d. As best seen in FIG. 4 and FIG. 9 upper wall section 20f′ and lower wall section 20f″ respectively angle upwardly and downwardly away from slot 20g and away from each other. As will be described later herein, the angling upper and lower wall sections 20f′ and 20f″ create a depression along one side of knife 10. Portions of locking mechanism 16 extend into this depression.

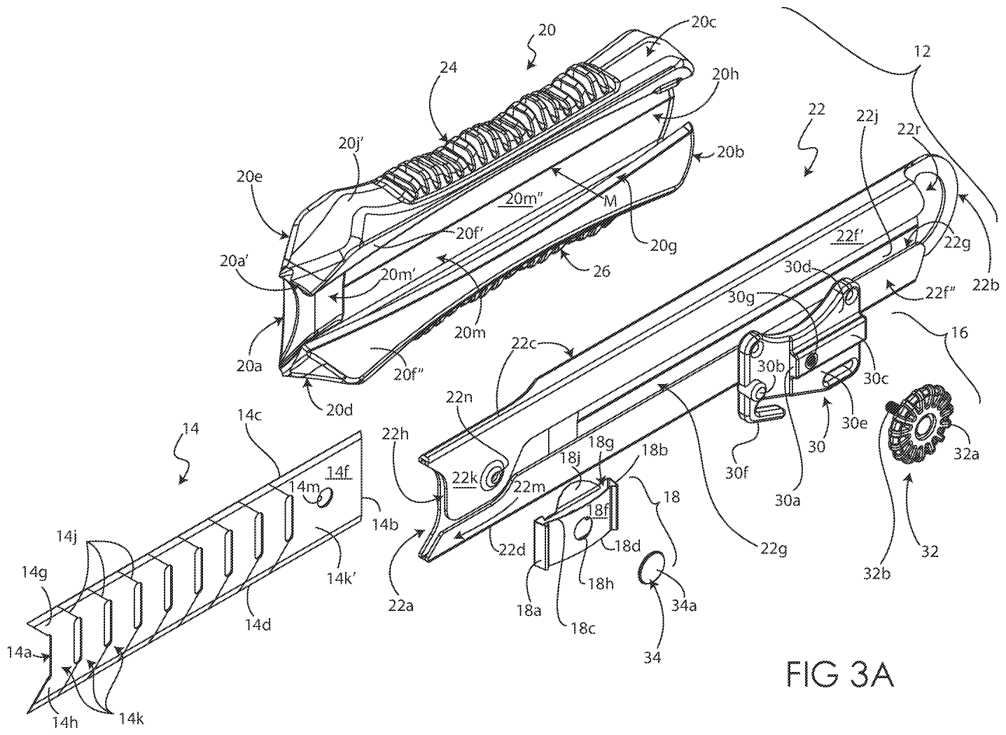

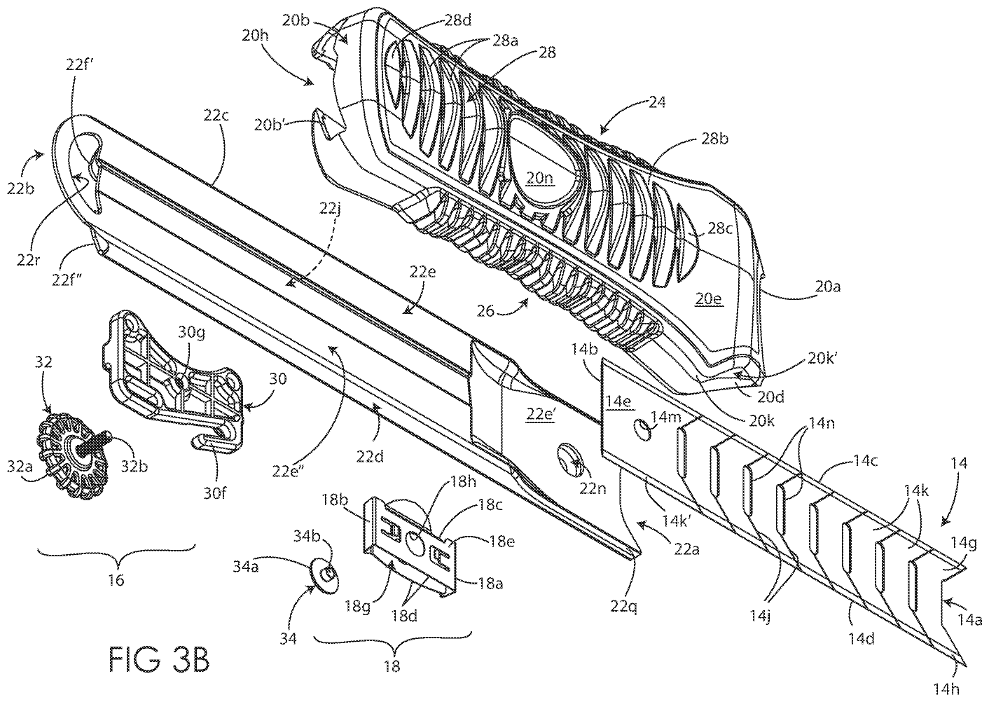

First housing section 20, when viewed from either of first end 20a or second end 20b, is generally C-shaped in cross-section. Together, top wall 20c, first side wall 20e, bottom wall 20d and second side wall 20f (i.e., 20f′ and 20f″) bound and define an interior cavity 20h. An opening 20a′ (FIG. 3A) defined by first end 20a, an opening 20b′ (FIG. 3b) defined by second end 20b, and slot 20g provide access into interior cavity 20h.

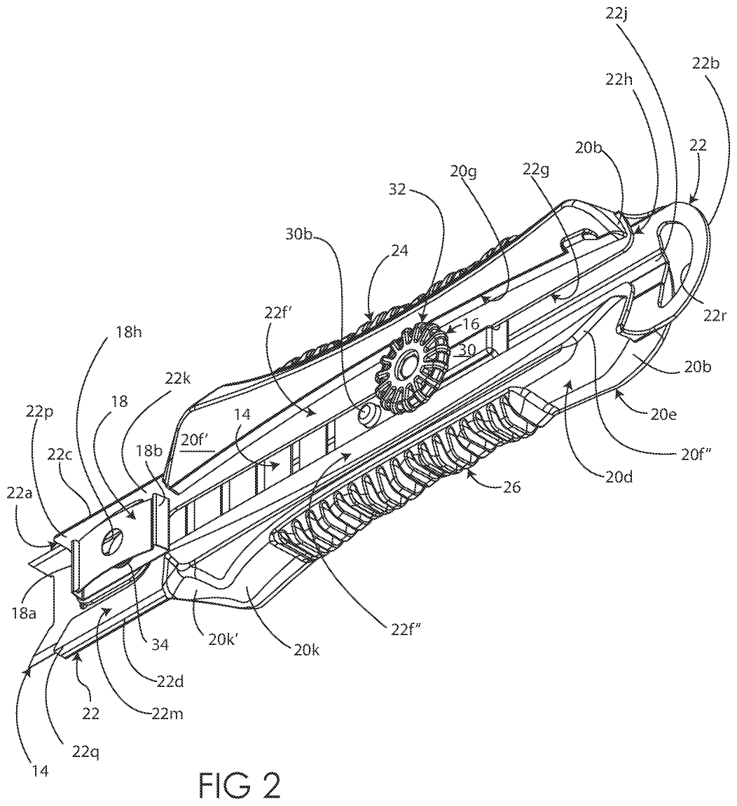

In accordance with an aspect of the present disclosure, top wall 20c and bottom wall 20d are substantially identical in configuration and are arranged on first housing section 20 as mirror images of each other. Each of top wall 20c and bottom wall 20d is formed to include a V-shaped region that is located a distance rearwardly from first end 20a. The V-shaped region on top wall 20c is identified by the reference number 20j (FIGS. 1 and 3A) and the V-shaped region on bottom wall 20d is identified by the reference number 20k (FIGS. 2 and 3B). The V-shaped region 20j on top wall 20c is an inverted V-shape relative to the V-shaped region 20k on bottom wall 20d. The two V-shaped regions 20j, 20k are transversely aligned with each other, with the apex of each V-shape being aligned along a transverse axis “X” (FIG. 4) that is oriented at 90 degrees relative to longitudinal axis “Y”.

FIG. 4 shows that top wall 20c is curved from V-shaped region 20j through to proximate second end 20b of first housing section 20. In particular, top wall 20c is concavely shaped from V-shaped region 20j to proximate second end 20b. Similarly, bottom wall 20d is curved from V-shaped region 20k through to proximate second end 20b of first housing section 20. In particular, bottom wall 20d is concavely shaped from V-shaped region 20k to proximate second end 20b.

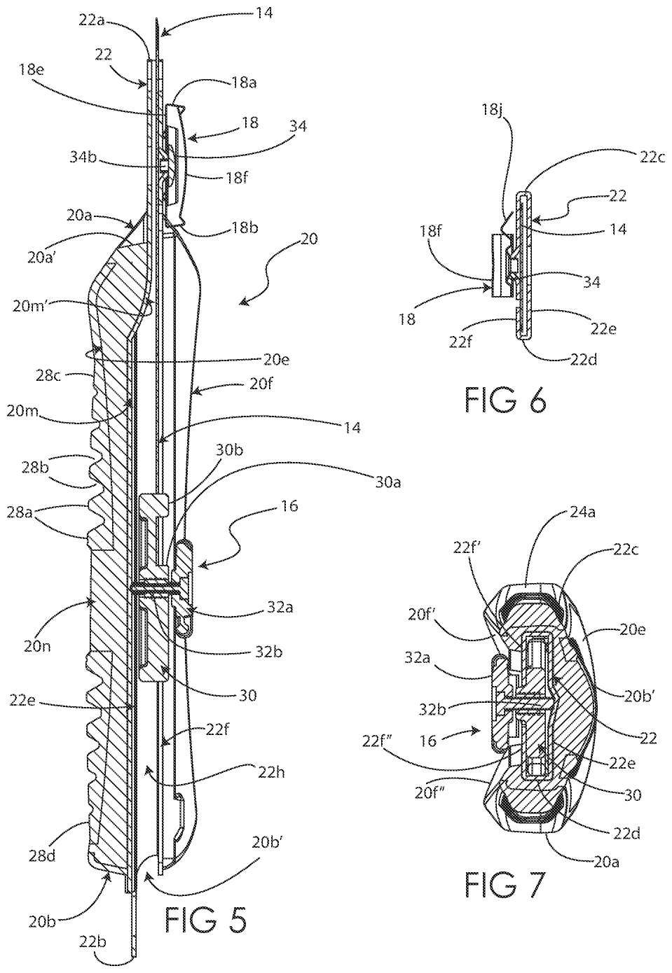

Referring to FIGS. 3A and 5, first side wall 20e of first housing section 20 has an interior surface 20m that bounds and defines part of interior cavity 20h. Interior surface 20m extends from first end 20a to second end 20b and includes a first section 20m′ and a second section 20m″. First section 20m′ originates proximate first end 20a and extends rearwardly for a distance toward second end 20b. First section 20m′ is curved, particularly generally convexly curved. Second section 20m″ is flat from first section 20m′ up to second end 20b. First section 20m′ projects inwardly into interior cavity 20h and towards second wall 20d and because of this, the width of the interior cavity 20h proximate first section 20m′ gradually narrows. The width is the distance between the interior surface of first side wall 20e and the interior surface of second side wall 20f. The width of interior cavity 20h as defined between second section 20m″ and second side wall 20f is substantially constant.

In accordance with another aspect of the present disclosure, a first overmold 24 is provided on top wall 20c and a second overmold 26 is provided on bottom wall 20d. First overmold 24 and second overmold 26 extend from a location rearward of the respective V-shaped region 20j, 20k to a location forward of second end 20b. First and second overmolds 24, 26 preferably are soft, resilient rubber overmolds but it will be understood that any other suitable material may be utilized for first and second overmolds 24, 26.

First and second overmolds 24, 26 are substantially identical in structure and function but are arranged on first housing section 20 as mirror images of each other. First overmold 24 includes a plurality of ribs 24a that are arranged so that a space 24b is defined between adjacent ribs 24a. The ribs 24a are of varying heights (where the height is the distance from curved top wall 20c to a free end of the rib). The ribs 24a are grouped by height to form alternating peaks and valleys giving the first overmold 24 the appearance of a sine wave when the front or back of the first housing section 20 is viewed (FIG. 4 or FIG. 8). Similarly, second overmold 26 includes a plurality of ribs 26a that are arranged so that a space 26b is defined between adjacent ribs 26a. The ribs 26a are of varying heights and are grouped by height to form alternating peaks and valleys, giving the second overmold 26 the appearance of a sine wave when the front or back of the first housing section 20 is viewed (FIG. 4 or FIG. 8). The undulating hills and valleys provide an ergonomically-shaped gripping region on first housing section 20 which aids in easing hand and wrist fatigue when the user is performing repetitive cutting motions.

As best seen in FIG. 1, portions of the first side wall 20e and second side wall 20f extend upwardly for a distance beyond the regions of top wall 20c that do not include first overmold 24. Similarly, as best seen in FIG. 2, portions of the second side wall 20f extend downwardly for a distance below regions of the bottom wall 20d that do not include second overmold 26.

Referring now to FIGS. 3B, 5, and 8, a third overmold 28 is provided on the exterior surface of first side wall 20e. Third overmold 28 is comprised of the soft, resilient rubber or any other suitable material used for first and second overmolds 24, 26. The overmolds 24, 26, 28 are durable and provided a non-slip, cushion grip that is able to be used by both left-handed and right-handed users in two different orientations. Third overmold 28 includes a plurality of upstanding ribs 28a that are spaced longitudinally from each other, with adjacent ribs 28a being separated from each other by a space 28b. Ribs 28a are oriented generally parallel to each other and at right angles to longitudinal axis “Y”. Substantially all of the ribs 28a are of the same height, with the height being measured from the exterior surface of first wall 20e to an outermost edge of the rib 28a. The majority of ribs 28a are of substantially the same width, measured in the transverse direction between top wall 20c, and bottom wall 20d, except for the ribs described hereafter. The majority of the ribs 28a have substantially vertical, slightly curved walls that bound and define part of the adjacent space 28b. At least a forwardmost and a rearmost of the ribs, indicated by the reference numbers 28c, 28d, respectively, are shorter in width and have one side that is straight and the opposing side is curved.

In addition to the differently shaped end ribs 28c, 28d, a rim 28e bounds and defines an aperture (FIGS. 3B, 5 and 8) in a region of overmold 28 that is generally centrally located along the length of first side wall 20e. The rim 28e and associated aperture are illustrated as being generally circular in shape. It will be understood, however, that the rim and aperture could be square or rectangular, or an irregular shape, if that is so desired. A projection 20n of first side wall 20e extends through the aperture bounded and defined by rim 28e. The projection 20n is complementary to the aperture defined by rim 28e. The projection 20n is illustrated as having a flattened outermost surface that is substantially flush with the height of the ribs 28a on third overmold 28. The projection 20n may, alternatively, be concavely or convexly curved but this is not shown in the attached figures. The purpose of projection 20n will be described later herein. Portions of ribs 28a extend outwardly from rim 28e towards top wall 20c and towards bottom wall 20d. These portions of ribs 28a are obviously not of the same width as the rest of the ribs 28a that flank rim 28e.

Turning now to FIGS. 3A, 3B, and 5, second housing section 22 is described in greater detail. Second housing section 22 has a first end 22a and a second end 22b defining a longitudinal direction between them. Second housing section 22 also includes a top wall 22c, a bottom wall 22d, a first side wall 22e, and a second side wall 22f. The exterior shape of second housing section 22 is such that a least a portion thereof is complementary to the interior shape of first housing section 20. (The interior shape of the first housing section 20 comprises the various surfaces that bound and define interior cavity 20h.) In particular, first side wall 22e is complementary in shape to the interior surface 20m of first side wall 20e. As such, the outer surface of first side wall 22e includes a first section 22e′ that is complementary in curvature to the curvature of curved first section 20m′ of first side wall 20e of first housing section 20. The outer surface of first side wall 22e also includes a flat second section 22e″ that is complementary to the flat second section 20m″ of first housing section 20.

Second side wall 22f is comprised of an upper section 22f′ and a lower section 22f″. An elongated slot 22g is defined between a lower edge of upper section 22f′ and an upper edge of lower section 22f″. Upper section 22f′, top wall 22c, first side wall 22e, bottom wall 22d, and lower section 22f″ bound and define an interior chamber 22h (FIGS. 3A, 5, and 10). A groove 22j is defined on an inner surface of first side wall 22e. Groove 22j extends longitudinally along the inner surface of first side wall 22e and is substantially aligned with slot 22g.

In accordance with the present disclosure, a forwardmost end 22k (FIG. 3A) of upper section 22f′ of second side wall 22f is of a greater height that the rest of the upper section 22f′, i.e., the distance between top wall 22c and the lowermost edge of forwardmost end 22k is greater than the distance between top wall 22c and the lowermost edge that defines slot 22g. (It can be seen that slot 22g effectively terminates in a rear edge of forwardmost end 22k.). A front end 22m of lower section 22f″ of second side wall 22f is of a smaller height than the rest of lower section 22f″. In other words, the distance from bottom wall 22d to an upper edge of front end 22m is shorter than the distance from bottom wall 22d to the upper edge of lower section 22f″ that defines slot 22g. The lowermost edge of forwardmost end 22k and uppermost edge of front end 22m are both curved in a complementary manner so that the two edges are in close proximity. Aligned apertures 22n (FIGS. 3A and 3B).

As best seen in FIGS. 3A, 3B and 4, first end 22a of second housing section 22 is generally U-shaped. In particular, the leading end of first side wall 22e is generally U-shaped and together, the leading ends of forwardmost end 22k and front end 22m together form a generally U-shaped edge. The U-shaped edge forms two tips 22p and 22q, the purpose of which will be described later herein.

In accordance with another feature of the present disclosure, first side wall 22e is longer than second side wall 22f. This can be seen in FIG. 3A. The rear edge of first side wall 22e forms the second end 22b of second housing section 22. This rear edge is convexly shaped, in particular, semi-circular. A hole 22r is defined in first side wall 22e a short distance forwardly from the rear edge. Hole 22r extends between the inner surface of first side wall 22e and the outer surface thereof. Hole 22r is illustrated herein as being generally semi-circular but any other shaped hole 22r may be formed therein. Hole 22r may be utilized to hang knife 10 on a peg board in a workshop, or may receive a clip to secure knife 10 to a tool belt etc.

Second housing section 22 is engaged with first housing section 20 by inserting second end 22b through opening 20a′ in first end 20a of first housing section 20 and into interior chamber 20h. Second housing section 22 is moved rearwardly until second end 22b thereof extends outwardly through opening 20b′ in second end 20b of first housing section 20. Rear movement of second housing section 22 is arrested when the curved first section 22e′ of first side wall 22e is complementarily nested with curved first section 20m′ of first side wall 20e of first housing section 22. Second housing section 22 may be retained in engagement with first housing section 20 by friction. Alternatively an adhesive may be applied to a portion of the exterior surface of second housing section 22 that will be proximate the interior surface of first housing section. The adhesive may be applied prior to inserting the second housing section 22 into the interior chamber 20h of first housing section 20. When second housing section 22 is engaged with first housing section 20, a first part of the second housing section 22 extends forwardly beyond first end 20a of first housing section 20; and a second part of second housing section 22 extends rearwardly beyond second end 20b of first housing section 20.

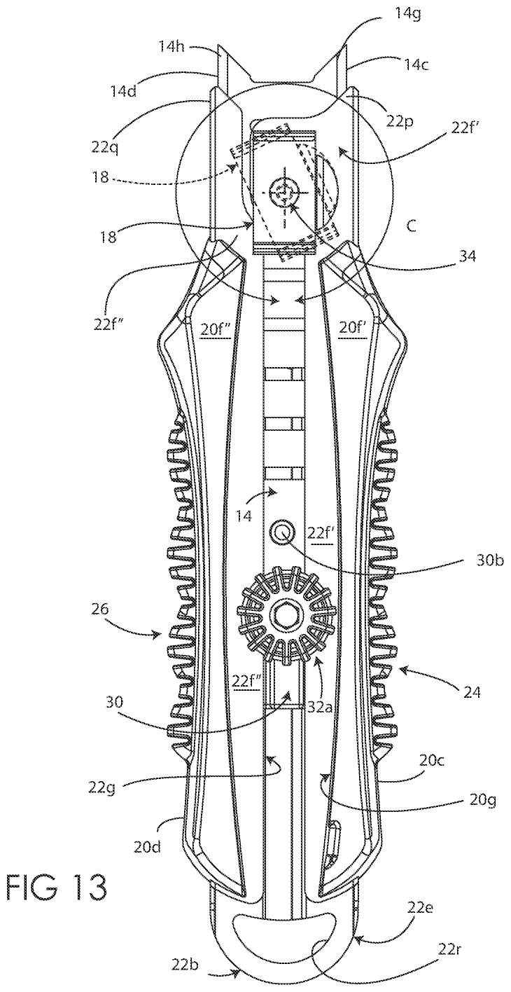

FIGS. 3A, 3B, 13A, and 13B show the first embodiment blade member 14 in greater detail. Blade member 14 comprises a planar sheet of metal which has a first end 14a, a second end 14b, a top edge 14c, a bottom edge 14d, a first side 14e (FIG. 3A), and a second side 14f. Blade member 14 has a midline that is substantially equidistant from the first edge and the second edge (and will be parallel to longitudinal axis “Y” and midline “M” of housing 12); and the blade member 14 is symmetrical about the blade member's midline. First end 14a is generally U-shaped and is configured such that two inverted V-shaped tips 14g, 14h are formed where first end 14a intersects top edge 14c and bottom edge 14d, respectively. Tips 14g and 14h extend outwardly from blade member in the same direction. Previously-known blade members used in previously-known utility knives have a single inverted V-shaped tip or have had two V-shaped tips but those two tips have been laterally aligned with each other and extending outwardly from a central region in opposite directions. Additionally, a single cutting edge has extended between these V-shaped tips in previously-known blade members. In order to use previously-known two-tipped blade members, a user had to open up the housing of the previously-known knives and had to rotate the blade through 180°. As will be described later herein, there is no need to open the housing 12 of the present knife 10 in order to present a fresh cutting surface.

Additionally, unlike previously-known blade members used with previously-known utility knives, both top edge 14c and the bottom edge 14d of blade member 14 are sharpened to form cutting surfaces. In previously-known blade members, only the bottom edge is sharpened into a cutting surface. This is the case even if the previously-known blade has had two tips extending in opposite directions from each other; the same single cutting surface is provided on that blade. Because of this arrangement, it is has been necessary for a user to open up the previously-known knife housing, rotate the previously-known blade through 180°, and then close the housing once again. In the presently disclosed knife 10, all that is required to provide a fresh cutting surface is to rotate the housing 12 through 180°.

Furthermore, because of the presence of two cutting surfaces 14c, 14d and two tips 14g, 14h, blade member 14, and thereby knife 10, is capable of being used in two different orientations that are 180 degrees apart. Previously-known utility knives have only been able to be used in a single orientation and that is with the single sharpened cutting surface (i.e., the sharped bottom edge) of the previously-known blade members positioned to contact a surface to be cut. With the presently-disclosed knife 10, either of the sharpened cutting surfaces of the top edge 14c and the bottom edge 14d may be brought into contact with a surface to be cut.

A plurality of lines of weakness 14j are defined at spaced intervals along the length of blade member 14. Each line of weakness 14j is substantially identical in configuration to front end 14a. In other words, each line of weakness 14j is substantially U-shaped. The lines of weakness separate blade segments from each other. FIGS. 3A and 3B show blade member 14 having eight lines of weakness 14j and thereby dividing blade member 14 into nine blade segments 14k. All of the blade segments 14k are identical except for the rearmost blade segment which is identified by the reference number 14k′. Blade segment 14k′ is larger than the other blade segments 14k and includes second end 14b. A hole 14m is defined in blade segment 14k′. Hole 14m extend from first side 14e through to second side 14f. A plurality of apertures 14n are defined in blade member 14 extending from first side 14e through to second side 14f. Each aperture 14n is positioned along one of the lines of weakness 14j.

Blade member 14 is received within interior chamber 22h of second housing section 22 in an orientation that places rearmost blade segment 14k′ closest to second end 20b of first housing section 20 and places a leading blade segment 14k (i.e., the one that includes first end 14a) closes to first end 20a of first housing section 20.

Blade member 14 is secured to second housing section 22 by locking mechanism 16. Locking mechanism 16 comprises a carriage 30 and a locking knob 32. FIG. 5, in particular, shows the engagement of blade member 14 with carriage 30 and locking knob 32. Carriage 30 is configured to be received within the interior chamber 22h of second housing section 22. Second end 14b of blade member 14 abuts a shoulder 30a (FIG. 3A) of carriage 30 and a pin 30b of carriage 30 extends through hole 14m defined in rearmost segment 14k′. A boss 30c of carriage 30 is configured and sized to be received through slot 22g defined between upper and lower sections 20f′, 20f″ of second housing section 22. Flanges 30d, 30e abut the interior surfaces of upper and lower sections 20f′, 20f″ and ride therealong as blade member 14 is extended or retracted relative to first end 22a of second housing section (as will be described later herein). An arm 30f extends downwardly from carriage 30 to ride along the upper surface of bottom wall 22d of second housing section 22. A threaded aperture 30g is defined in carriage 30 and this aperture 30g extends from a first side of carriage to a second side thereof.

Locking knob 32 includes a head 32a and a threaded shaft 32b. Shaft 32b passes through aperture 30g in carriage 30 and the threads on shaft 32b threadably engage the threads bounding aperture 30g. A free end of shaft 32b is received within groove 22j defined in first side wall 22e of second housing section 22. When locking knob 32 is rotated in a first direction, the free end of shaft 32b does not contact the inner surface of first end wall 22e and carriage 30 is therefore able to be moved longitudinally within interior chamber 22h in one of a first direction “A” (FIG. 1) or a second direction “B”. When locking knob 32 is rotated in a second direction, the free end of shaft 32b contacts the inner surface of first end wall 22e, and carriage 30 cannot be moved in either of the first direction “A” or the second direction “B”. Consequently, when a person wishes to extend blade member 14 in such a way that the first segment 14k is located beyond first end 22a of second housing member 22, the locking knob 32 is rotated in the first direction and the person is able to slide blade member in the first direction “A” by grasping locking knob 32 and moving it toward first end 22a. When a desired sufficient length of blade member 14 extends beyond first end 22a, the locking knob 32 is rotated in the second direction to lock carriage 30 and thereby blade member 14 against further longitudinal movement. As is illustrated in FIG. 4, when the first blade segment 14k extends outwardly beyond first end 22a, the tips 22p, 22q of second housing member 22 extend for a distance along first and second sides 14e, 14f, and along portions of the cutting surfaces 14c, 14d of blade member 14 and protect the same. Knife 10 may be held in a person's left hand or right hand in one of two different orientations to contact a surface to be cut with either of the two cutting surfaces 14c, 14d.

As indicated earlier herein, knife 10 also includes a tape engagement clip 18. Tape engagement clip 18 is provided to enable a person to lock a free end of a measuring tape therein, as will be described later herein. Tape engagement clip 18 shown in FIGS. 1-12 is a first embodiment tape engagement clip that may be selectively engaged with knife 10.

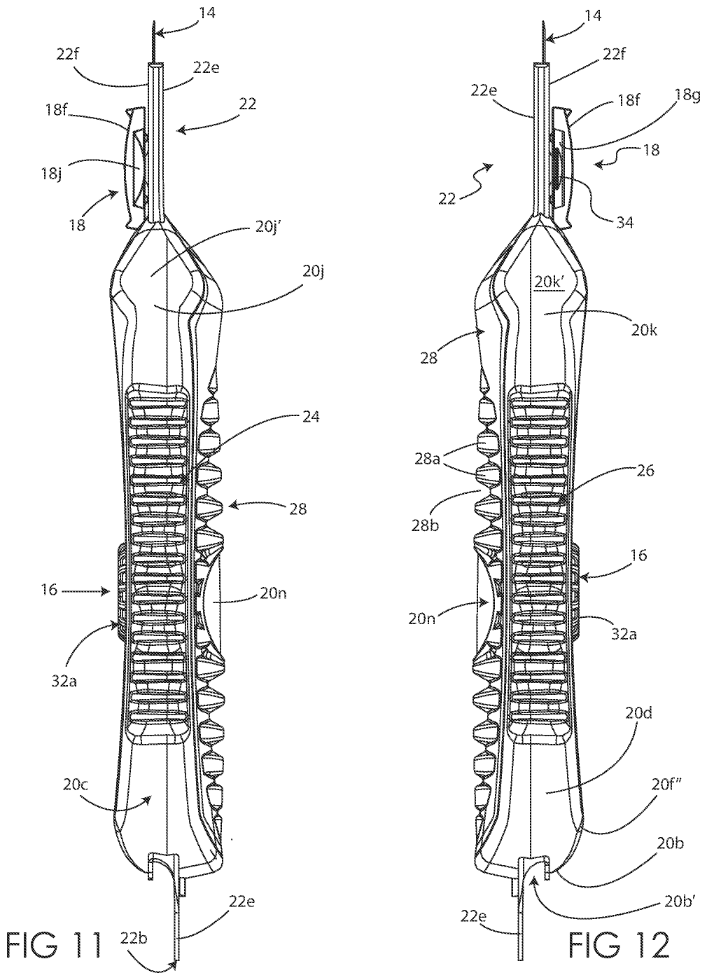

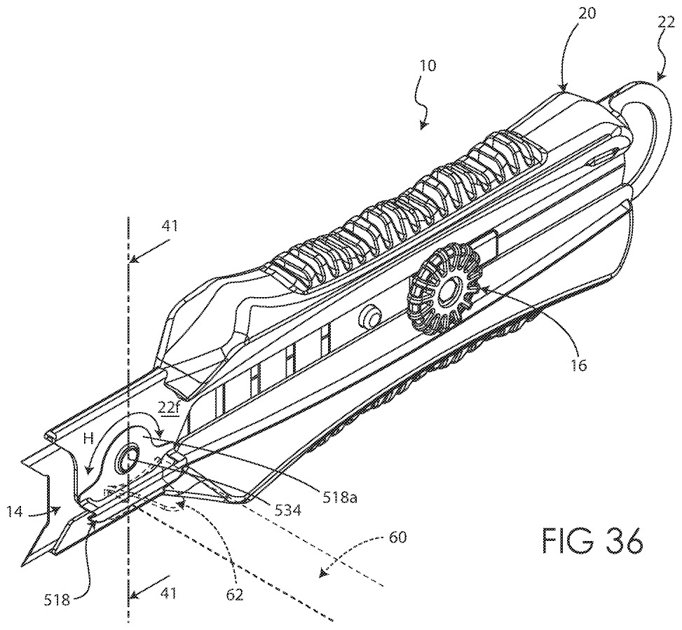

FIGS. 3A and 3B show tape engagement clip 18 includes a first end 18a, a second end 18b, a top edge 18c, a bottom edge 18d, a first side wall 18e and second side wall 18f bound and define a passage 18g that has openings in top edge 18c and in bottom edge 18d. Aligned apertures 18h are defined in first side wall 18e and second side wall 18f. A tab 18j extends upwardly from top edge 18c of first side wall 18e. A fastener 34 has a head 34a and a shaft 34b (FIG. 36). Fastener 34 is utilized to secure tape engagement clip 18 to knife 10 by inserting shaft 34b through aperture 18h in first side wall 18e of tape engagement clip 18 and into the aperture 22n in one or the other of first side wall 22e or second side wall 22f of second housing section 22. FIGS. 11-13 show tape engagement clip 18 engaged with second side wall 22f of second housing section 22. FIG. 13 shows that tape engagement clip 18 is able to rotate about the shaft of fastener 34 through 360°. In other words, tape engagement clip 18 is able to rotate about an axis that is oriented at right angles to longitudinal axis “Y”. This ability to rotate clockwise or counterclockwise is indicated by the arrow “C”. A person will rotate tape engagement clip 18 to orient it correctly to engage with a measuring tape depending on whether they intend to use the cutting surface of bottom wall 14d of blade member 14 or the cutting surface of top wall 14c of blade member 14. This will be described hereafter.

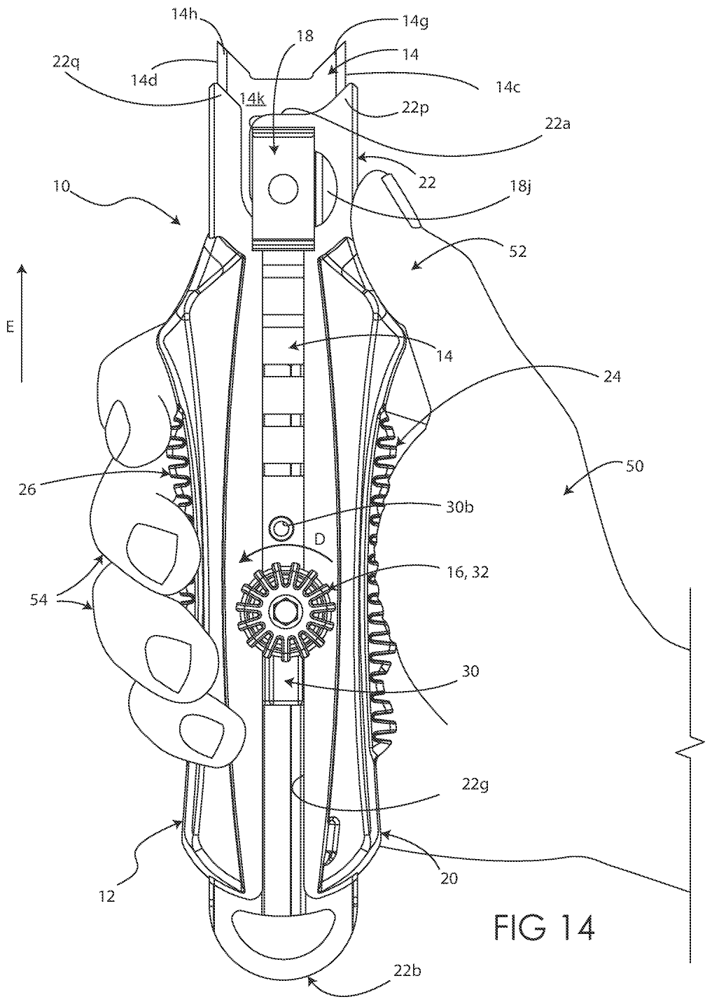

Referring to FIGS. 13-18, knife 10 may be used in the following manner. Initially, blade member 14 may be retracted into the housing 12 so that neither cutting surface (14c, 14d) is able to be accidentally contacted. In a retracted position, the tips 14g, 14h of blade member are positioned inwardly of the tips 22p, 22q of second housing section 22. In order to advance the blade outwardly from the second housing section 22, the user will rotate the locking knob 32 of locking mechanism 16 in a counter-clockwise direction indicated by arrow “D” in FIG. 14 and will then push on the knob 32 to move the same in the direction indicated by arrow “E”. In other words, the person will slide the knob 32 along the slot 22g in the direction of arrow “E”. When the desired number of blade segments 14k extend outwardly beyond first end 22a of second housing section 22, the user will rotate the locking knob 32 of locking mechanism 16 in the opposite direction to arrow “D”. This motion will bring the end of the shaft 32b of locking member 32 into contact with the first side wall 22e and prevent any further sliding movement of blade member 14 along second housing section 22.

FIG. 14 shows knife 10 being gripped in a person's right hand 50. The person's palm contacts the first overmold 24, resting comfortably on the undulating hills and valleys of the first overmold 24. The person's fingers 54 curl around the first housing section 20 and rest on the undulating hills and valleys of the second overmold 26. In this orientation, the insides of the fingers will also rest comfortably on the third overmold 28 (which is not illustrated in FIG. 14). The pad of the person's thumb 52 rests on an upward-curving surface 20j′ (FIG. 1) of V-shaped region 20j of top wall 20c, positioning the thumb to be able to apply downward force on knife 10. In the orientation shown in FIG. 14, the knife 10 is being readied to utilize the cutting surface of the bottom edge 14d of blade member 14. Tape engagement clip 18 is rotated so that the tab 18j extends away from the cutting surface to be used. In other words, the tape engagement clip 18 is oriented so that the tab 18j is located closest to the person's thumb 52 resting on surface 20j′.

It will be understood that, on other occasions, the knife 10 may be rotated through 180 degrees to present the cutting surface of the top edge 14c of blade member 14 to cut a surface. If this is the case, then the person's thumb pad will rest on the upward-curving surface 20k′ (FIG. 2) of V-shaped region 20k of bottom wall 20d, their palm will contact the second overmold 26, and their fingers will rest on the first overmold. Additionally, tape engagement clip 18 will be rotated in either direction indicated by arrow “C” to position the tape engagement clip 18 opposite to the orientation shown in FIG. 14. In other words, the tab 18j will extend away from cutting surface 14c and will be positioned closest to the person's thumb 52 resting on curved surface 20k′. The person will then bring the desired cutting surface, 14c, or 14d (depending on how the knife 10 is being held) into contact with the surface to be cut and will slide the cutting surface along that surface to make the desired cut.

The surfaces 20j′ and 20k′ also advantageously position the person's thumb proximate the first side wall 22e and second side wall 22f of second housing section 22. Should the user not wish to engage a tape engagement clip 18 with knife 10, the location of surfaces 20j′ and 20k′ places the thumb in the correct position to hold the end of the measuring tape against one or the other of the first section wall 22e and second side wall 22f.

Additionally, when the pad of the person's thumb is resting on one or the other of the surfaces 20j′ and 20k′, the locking knob 32a of locking mechanism 16 does not need to be positioned against the user's palm. In previously-known utility knives, if a left-handed user grasps the knife in the only orientation that can be used to cut a surface, the head of the locking knob will contact the user's palm. This contact causes the person to grip the previously-known utility knives awkwardly and this leads to premature fatigue of hand and wrist. In the presently known knife 10, the configuration of the upper and lower sections 20f′ and 20f″ of the second side wall 20f also helps to reduce the likelihood of the person contacting the head 32a of the locking knob 32 with their hand. The upper and lower sections 20f′, 20f″ angle outwardly away from each other and thus effectively recess at least a portion of the head 32a of the locking knob 32 a distance away from the user's palm. The effective recessing of the head 32a of the locking knob 32 can be seen in FIG. 7, for example.

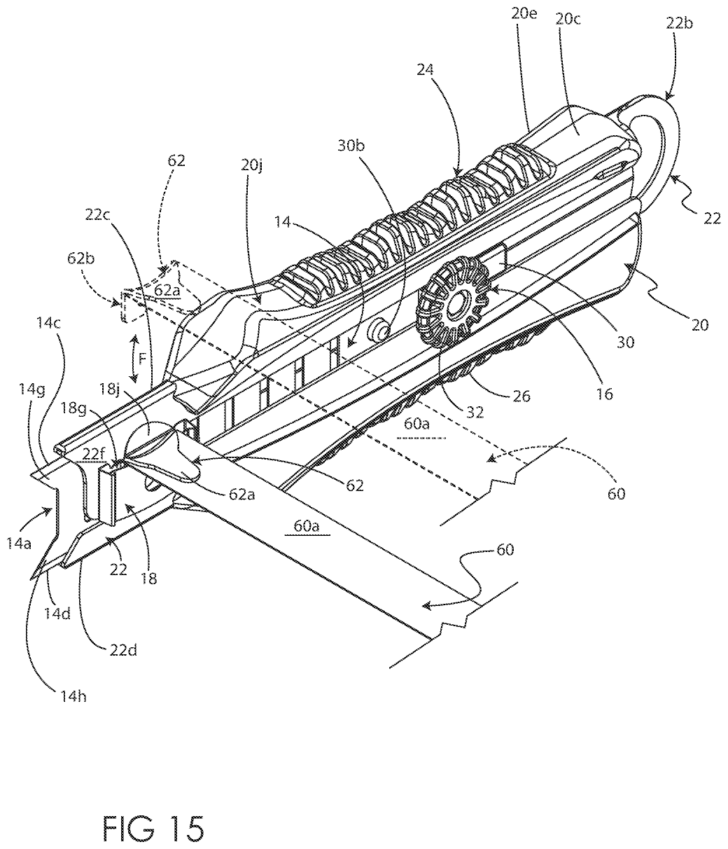

As indicated earlier herein, knife 10 is particularly well suited to cut drywall sheets. The person may desire to measure the width of the drywall sheet to be cut simultaneously with making the cut. In order to make this possible, the person will engage a measuring tape 60 with knife 10. This is shown in FIG. 15. Measuring tape 60 includes a flexible strip 60a which may extend outwardly from a housing (not shown) and includes a plurality of measurement markings thereon (not shown). The strip 60a is provided with rigid metal end 62 that has a horizontal first leg 62a engaged with the strip 60a and a vertical second leg 62b which extends downwardly at right angles to the strip 60a. In accordance with an aspect of the present disclosure, the person will firstly ensure that tape engagement clip 18 is in the correct orientation relative to which cutting surface 14c, 14d of blade member 14 is to be used. The person may grasp tab 18j to rotate the tape engagement clip 18 in either direction indicated by arrow “C” (FIG. 13. The person will then withdraw a length of the strip 60a of measuring tape 60 from the tape's housing (not shown) and will align the second leg 62b of the end 62 with the passage 18g defined in tape housing assembly 18. The person will then lower end 62 towards tape engagement clip 18 and cause the vertical second leg 62b thereof to enter passage 18g of tape engagement clip 18. This movement interlockingly engages measuring tape 60 with knife 10. The strip 60a of measuring tape 60 is held at ninety degrees to the longitudinal axis “Y” of the knife 10 by engaging end 62 with tape engagement clip 18.

Once measuring tape 60 is engaged with knife 10, the person is able to position a measurement marking on the strip 60a that is remote from the knife 10 and end 62 with an edge of a drywall sheet. The cutting surface of the knife 10 is then drawn along the drywall sheet cutting the same at the desired distance from the edge of the sheet. The knife 10 holds the end 62 of the measuring tape 60 to it, making it possible for the person to concentrate on measuring the desired distance more accurately instead of struggling to hold the end of the tape adjacent the knife as was done in the past. Because tape measuring assembly 18 is capable of rotating about the shaft of fastener 34, the tape 60 will not be twisted and rotated as the person seeks to properly angle the knife 10 to enable the blade member 14 to cut the surface of the drywall sheet. In some instances, for example, the measuring tape is oriented at 90 degrees relative to the drywall and the knife is perhaps oriented at an angle of about 45 degrees to the drywall. The fact that the tape engagement clip 18 is able to rotate or swivel about an axis oriented at right angles to the longitudinal axis “Y” helps to eliminate misalignment between measuring tape 60a, knife 10, and a sheet of drywall.

When it is no longer desired to engage measuring tape 60 with knife 10, the person will simply lift end 62 upwardly to withdraw second leg 62b out of passage 18g. The lowering of end 62 toward tape engagement clip 18 and the raising of end 62 from its engagement with tape engagement clip 18 is identified in FIG. 15 by the arrow “F”.

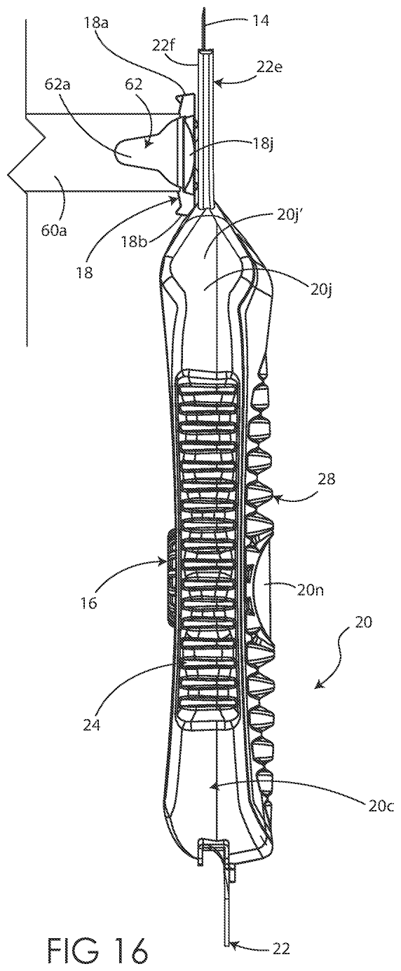

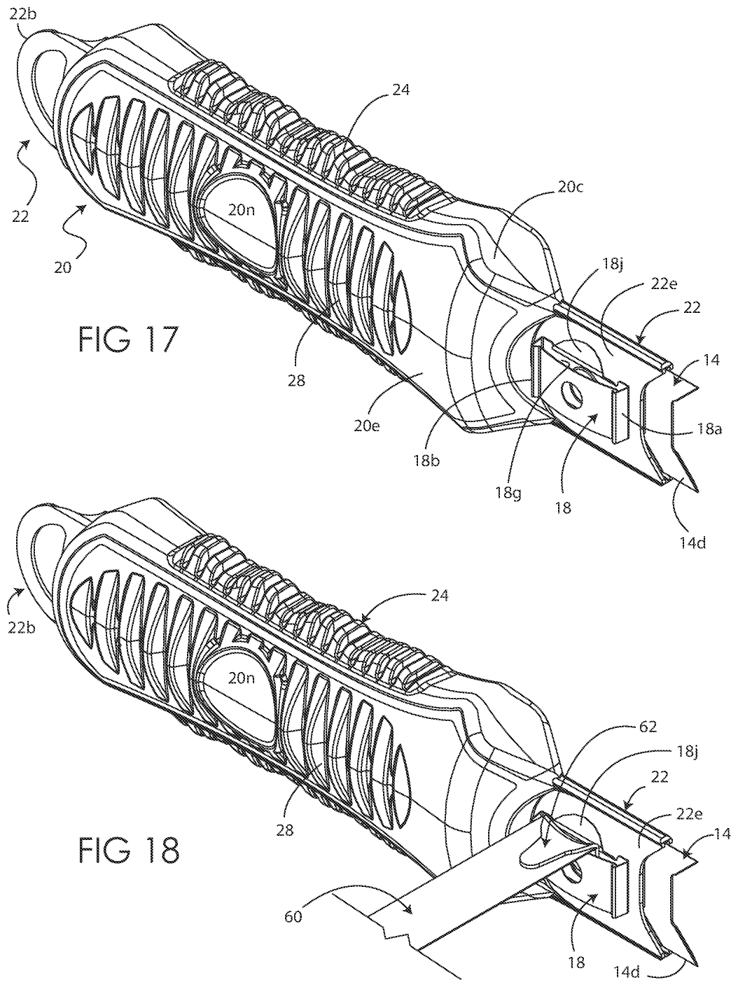

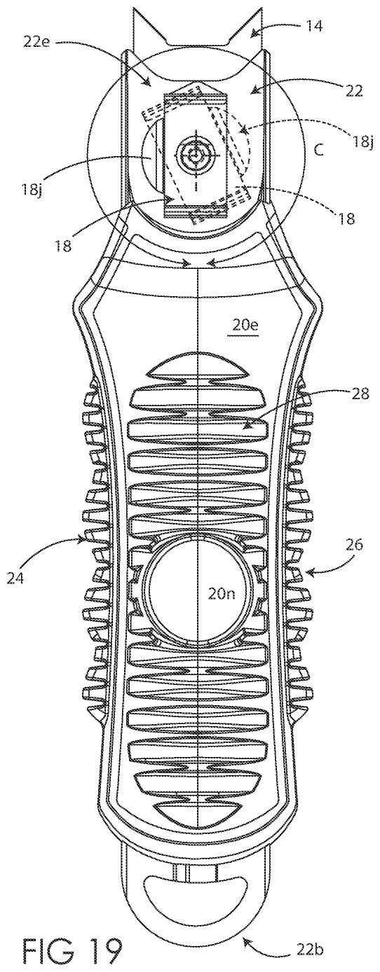

FIGS. 17-19 show tape engagement clip 18 engaged with the first side wall 22e of second housing section 22. In order to remove tape engagement clip 18 from the second side wall 22f (shown in FIG. 16), the person will simply position their thumb against a first end 18a of tape engagement clip 18 and will position their index finger against second end 18b thereof and will pull tape engagement clip 18 outwardly at right angles to second side wall 22f to disengage fastener 34 from hole 22n (FIG. 3A). Tape engagement clip 18 will then positioned with its first wall 18e in contact with first side wall 22e and the shaft of fastener 34 aligned with hole 22n in first side wall 22e, and then person will then push tape engagement clip 18 toward first side wall 22e to snap-fittingly engage fastener 34 in hole 22n. The person is able to manipulate tape engagement clip 18 into the desired orientation by grasping tab 18j and rotating assembly 18 in either direction indicated by arrow “C” in FIG. 19. A measuring tape 60 may then be engaged with tape engagement clip 18 as previously described.

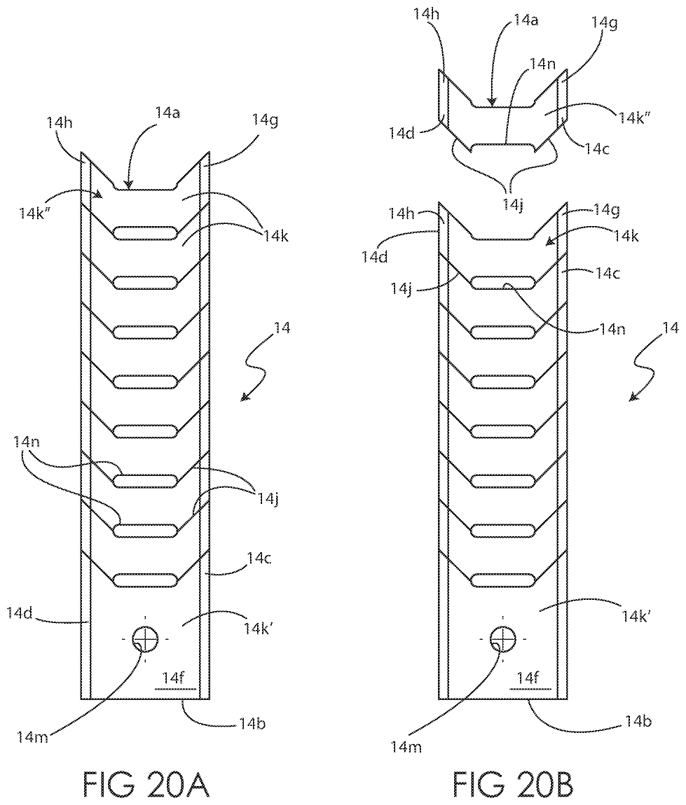

FIGS. 20A and 20B, show the first embodiment blade member 14 on its own. FIG. 20A shows a new/replacement blade member 14 that comprises a plurality of blade segments 14k that are separated from each other by lines of weakness 14j. The first end 14c and the second edge 14d both present sharpened cutting surfaces. FIG. 20B shows the leading blade segment 14k″ snapped off of the rest of the blade member 14. This will be done when the portions of the cutting surfaces 14c, 14d that are present on blade segment 14k″ have become too dull for use. The blade segment 14k″ is able to be snapped off the rest of blade member 14 in the same manner as in previously known utility knife blades. When blade segment 14k″ is removed from blade member 14, the new leading blade segment 14k includes sharped cutting surfaces on each of the first and second edges 14c, 14d and includes tips 14g and 14h. In other words, the new leading blade segment 14k is identical to the removed blade segment 14k″.

When all of the blade segments 14k have been removed from blade member 14 except blade segment 14k′ (i.e., the rearmost segment), and the cutting surfaces 14c, 14d of rearmost blade segment 14k′ are too dull for use, blade member 14 may be disengaged from carriage 30 and a new blade member (such as the one illustrated in FIG. 20A may be engaged with carriage 30.

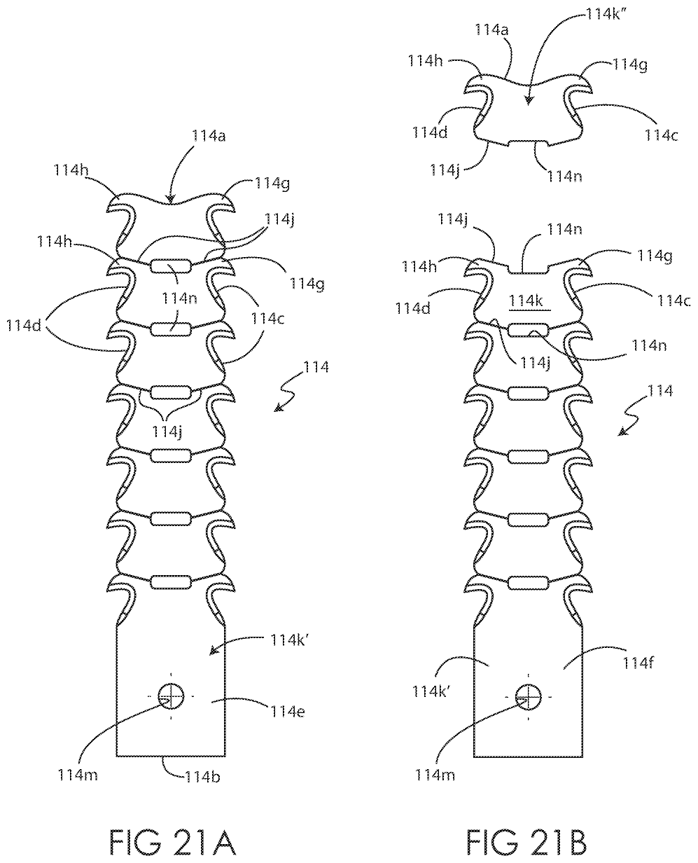

FIGS. 21A and 21B show a second embodiment blade member 114 that may be utilized with knife 10. Blade member 114 comprises a planar sheet of metal which has a first end 114a, a second end 114b, a top edge 114c, a bottom edge 114d, a first side 114e (FIG. 21A), and a second side 114f (FIG. 21B). A plurality of lines of weakness 14j are defined along blade member extending from top edge 114c to bottom edge 114d. The lines of weakness divide blade member 114 into a plurality of blade segments 114k that are substantially identical in configuration to each other with the exception of the rearmost blade segment 114k′. A hole 114m is defined in rearmost blade segment 114k′ that is utilized in the same manner as hole 14m in rearmost blade segment 14k′ to help engage blade member 114 to carriage 30 of knife 10. An aperture 114n is defined centrally in each line of weakness 114j and performs the same function as the aperture 14n in blade member 14.

First end 114a of blade member 114 (and all lines of weakness 114j) is generally U-shaped. Top and bottom edges 114c, 114d together with first end 114a form two J-shaped tips 114g, 114h that are oriented as mirror images of each other on each blade segment 114k of blade member 114. These hook-shaped tips 114g, 114h are particularly useful for cutting surfaces such as roofing shingles.

Blade member 114 is utilized in knife 10 in exactly the same manner as blade member 14. When cutting surfaces 114c, 114d become dulled on the leading blade segment 114k″, that segment is simply snapped off blade member 114. The blade segment which then forms the leading edge of blade member 114 is substantially identical to the removed blade segment 114k″. When the rearmost blade segment's cutting surfaces become dulled, rearmost blade segment 14k′ is disengaged from the carriage 30 on knife 10 and a new, replacement blade segment 114 (or blade segment 14) is engaged therewith.

Additionally, unlike previously-known blade members used with previously-known utility knives, both top edge 114c and the bottom edge 114d of blade member 114 are sharpened to form cutting surfaces. In previously-known blade members, only the bottom edge is sharpened into a cutting surface. Because of the presence of two cutting surfaces 114c, 114d and two tips 114g, 114h, blade member 114, and thereby knife 10, is capable of being used in two different orientations that are 180 degrees apart. Previously-known utility knives have only been able to be used in a single orientation and that is with the single sharpened cutting surface (i.e., the sharped bottom edge) of the previously-known blade members positioned to contact a surface to be cut. With the presently-disclosed knife 10, either of the sharpened cutting surfaces of the top edge 114c and the bottom edge 114d may be brought into contact with a surface to be cut.

The presence of these two cutting surfaces on a single blade segment 14k, 114k means that the knife 10 that includes blade member 14 or 114 can be used for twice as long as previously known knives without requiring the user to snap off a blade segment or to physically open the knife housing to rotate the presented blade segment through 180° to present a fresh, sharp cutting surface for use.

It will be understood that other differently configured blade members may be utilized with knife 10, where those other differently configured blade members have two opposed cutting surfaces other than the V-shaped or J-shaped configurations disclosed herein. For example, a different type of blade member (not shown) may include one V-shaped tip (such as tip 14g or 14h) and one J-shaped tip (such as tip 114g or 114h).

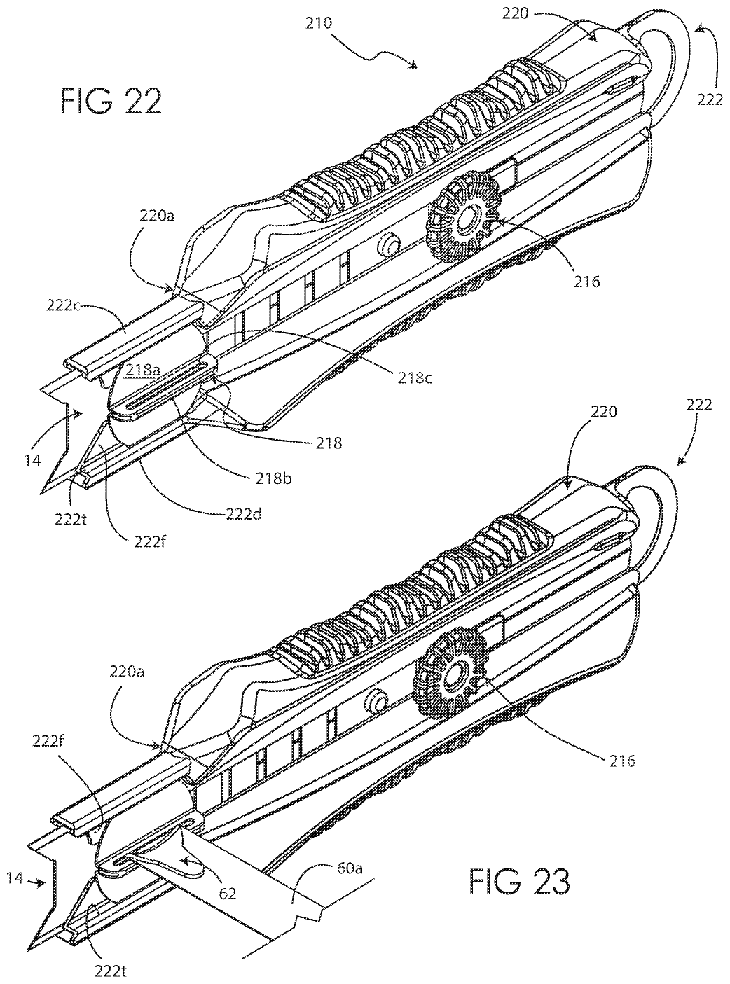

Referring now to FIGS. 22-27 there is shown a second embodiment of a knife in accordance with the present disclosure that includes a second embodiment tape engagement clip. The second embodiment knife is indicated in these figures by the reference number 210 and the second embodiment tape engagement clip is indicated by the reference number 218. Knife 210 is substantially identical in structure and function to knife 10 except for the leading end of the second housing section 222. First housing section 220 and locking mechanism 216 are identical to first housing section 20 and locking mechanism 16 and therefore will not be further discussed with respect to FIGS. 22-27. A blade member 14 is shown engaged with knife 210 but blade member 114 (FIG. 21A or 21B) may be utilized therewith instead.

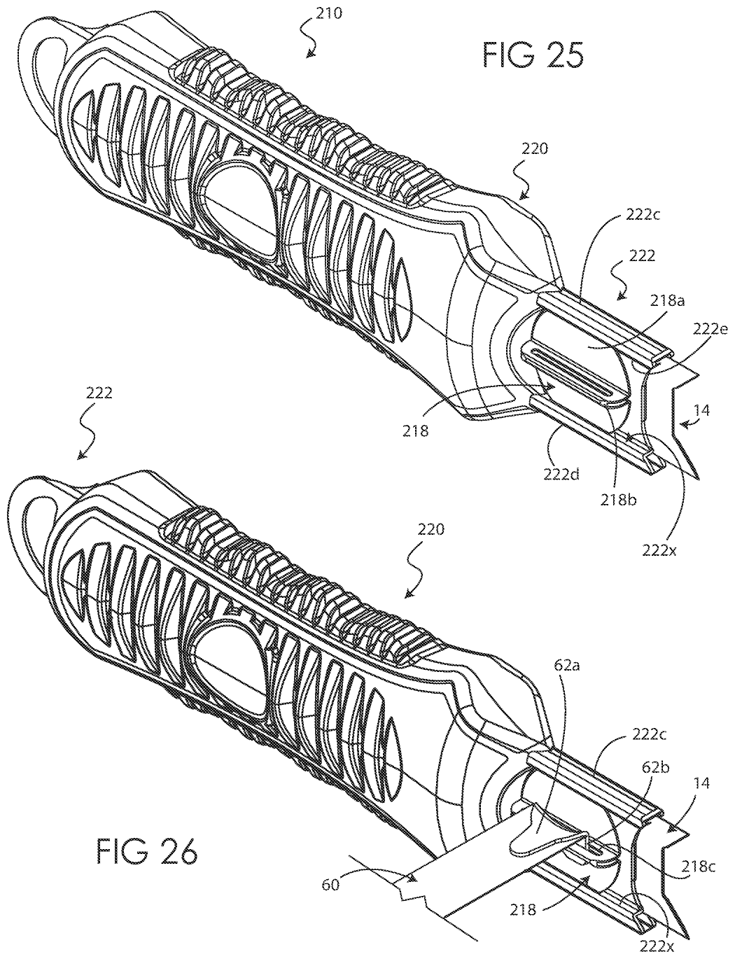

Second housing section 222 is substantially identical to second housing section 22 in structure and function except for the forwardmost portions of top wall 222c and bottom wall 222d that extend outwardly and forwardly from the first end 220a of first housing section 220. The forwardmost portions of top wall 222c and bottom wall 222d are wider (measured between first side wall 222e shown in FIG. 25 and second side wall 222f shown in FIG. 22). Top wall 222c and bottom wall 222d each define a pair of laterally-spaced, longitudinally-oriented channels therein, such as channels 222t (FIGS. 22 and 23) and 222x (FIGS. 25 and 26). The channels 222t, 222x in top wall 222c and bottom wall 222d are vertically aligned with each other and are opposed. The purpose of channels 222t, 222x) will be discussed further below.

Tape engagement clip 218 comprises a plate 218a and a flange 218b that extends outwardly from an outer surface of plate 218a. Plate 218a is substantially circular in shape, and flange 218b is oriented at right angles to the outer surface of plate 218a. Flange 218b is formed by creating a fold in the material utilized to form plate 218a although in other embodiments, flange 218b may be welded or otherwise secured to outer surface of plate 218a. Flange 218b preferably is oriented along a diameter of plate 218a although this is not necessary. As shown in FIG. 22, flange 218b defines a passage 218c that extends from an upper surface of flange 218b through to a lower surface thereof. Passage 218c is sufficiently long enough and wide enough to receive the vertical leg of the end 62 of a measuring tape 60 therethrough as shown in FIG. 22.

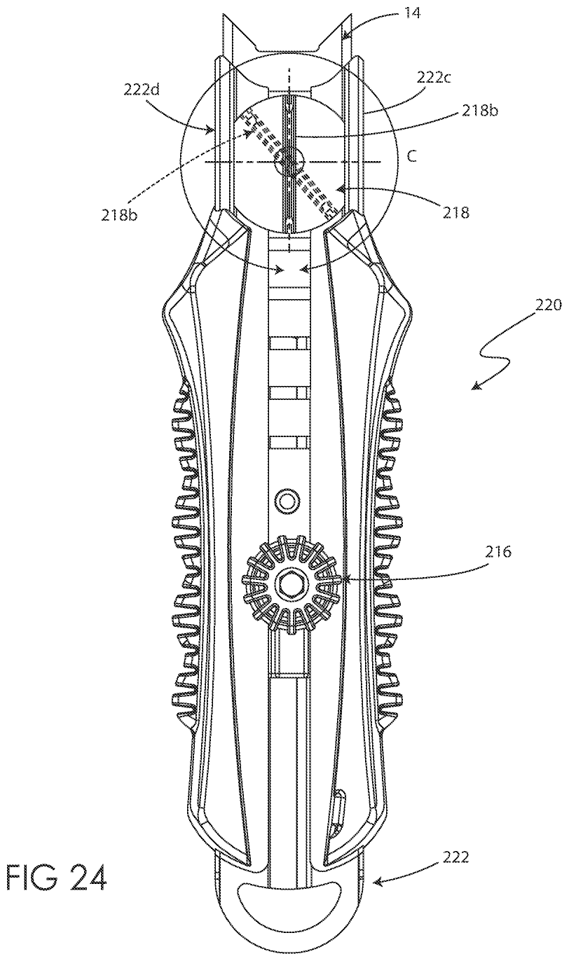

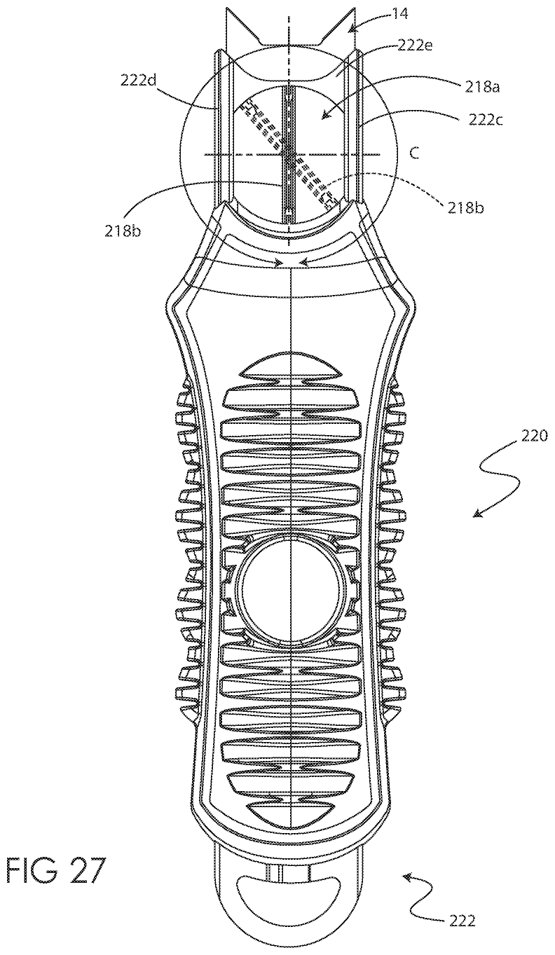

Plate 218a is of a thickness (measured between the outer surface and an inner surface thereof) that is complementary to the width of channels 222t, 222x. Plate 218a is received in opposed channels 222t in top and bottom walls 222c, 222d such that the inner surface of plate 218a is placed in abutting contact with second side wall 222f as shown in FIG. 22 Alternatively, tape engagement clip 218 may be engaged in channels 222x in top and bottom walls 222c, 222d such that the inner surface of plate 218a is placed in abutting contact with first side wall 222e (FIGS. 25-28). Plate 218a may be rotated within the opposed channels 222t or 222x as indicated by the arrow “C” in FIG. 24 or FIG. 27. In other words, plate 218a may be rotated about an axis extending at right angles to longitudinal axis “Y”. The rotation of plate 218a may be accomplished by the user grasping flange 218b between their thumb and index finger and rotating the same. Tape measuring assembly 218 may be moved between the position shown in FIG. 22 and the position shown in FIG. 25 simply by sliding plate 218a out of the aligned opposed channels 222t or 222x, rotating the plate 218a through 180°, and then reinserting the plate 218a into the other of the channels 222t, 222x on the opposite side of second housing section 222. Knife 210 is used in substantially the same manner as knife 10.

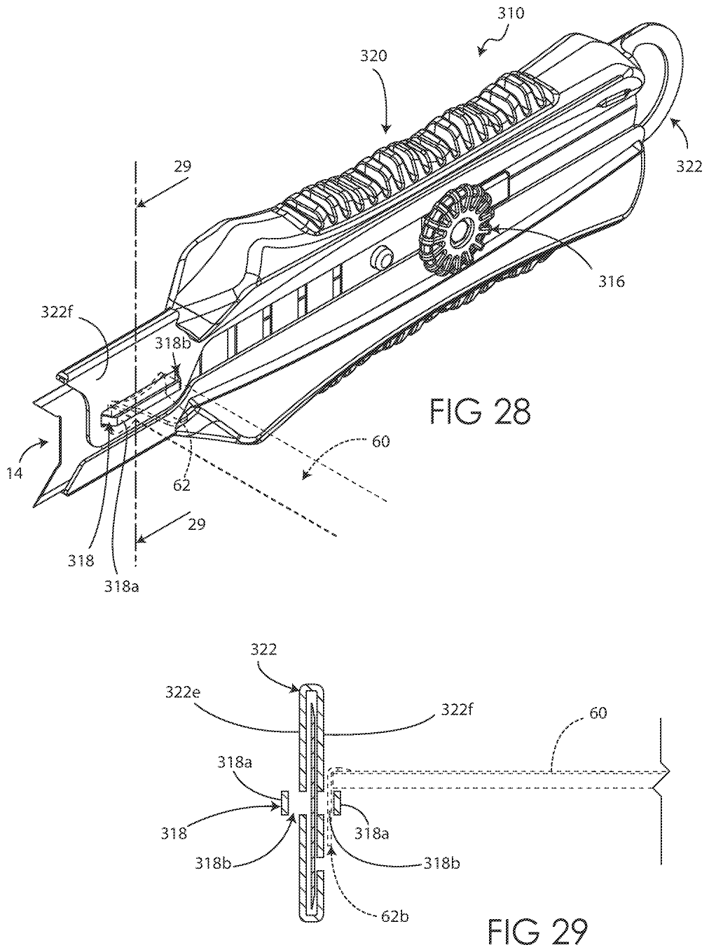

Referring now to FIGS. 28 and 29 there is shown a third embodiment of a knife in accordance with the present disclosure which includes a third embodiment tape engaging assembly. The third embodiment knife is indicated in these figures by the reference number 310 and the third embodiment tape engagement clip is indicated by the reference number 318. Knife 310 is substantially identical in structure and function to knife 10 except for the leading end of the second housing section 322. First housing section 320 and locking mechanism 316 are identical to first housing section 20 and locking mechanism 16 and therefore will not be further discussed with respect to FIGS. 28 and 29. A blade member 14 is shown engaged with knife 310 but blade member 114 (FIG. 21A or 21B) may be utilized therewith instead.

Second housing section 322 is substantially identical to second housing section 22 except that the aligned holes 22n are missing. The third embodiment tape engagement 318 assembly comprises a U-shaped bracket 318a that defines a passage 318b between the bracket and one of the first side wall 322e and the second side wall 322f, or each of the first side wall 322e and second side wall 322f. Bracket 318a is oriented substantially parallel to the longitudinal axis “Y” of knife 10. The passage 318b is of a sufficient length and width to receive the vertical leg of the end 62 of measuring tape 60 therethrough, as has been previously described herein. Unlike the first and second embodiments of tape engaging clip18, 218, the presently disclosed third embodiment of the tape engaging clip318 is not able to rotate about an axis oriented at right angles to longitudinal axis “Y”.

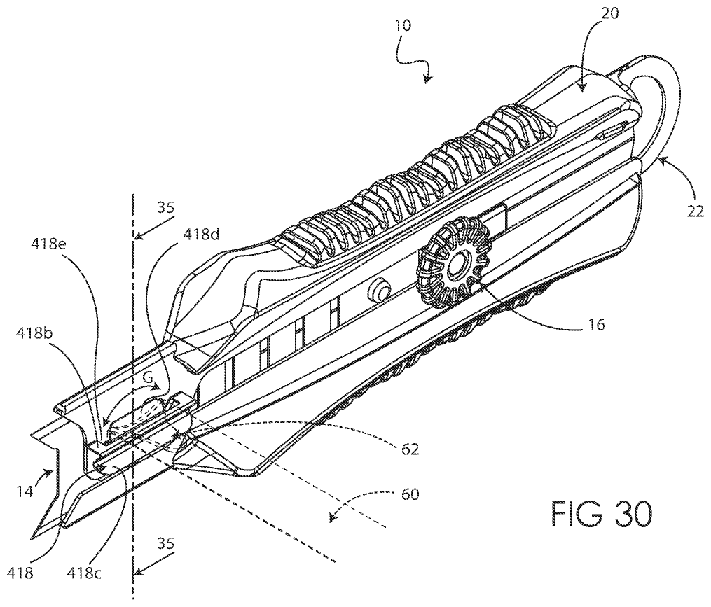

Referring now to FIGS. 30-35, utility knife 10 is shown with a fourth embodiment tape engaging clip engaged therewith. Utility knife 10 is identical to the knife 10 illustrated and described with reference to FIGS. 1-19. The fourth embodiment tape engagement clip is indicated by the reference number 418.

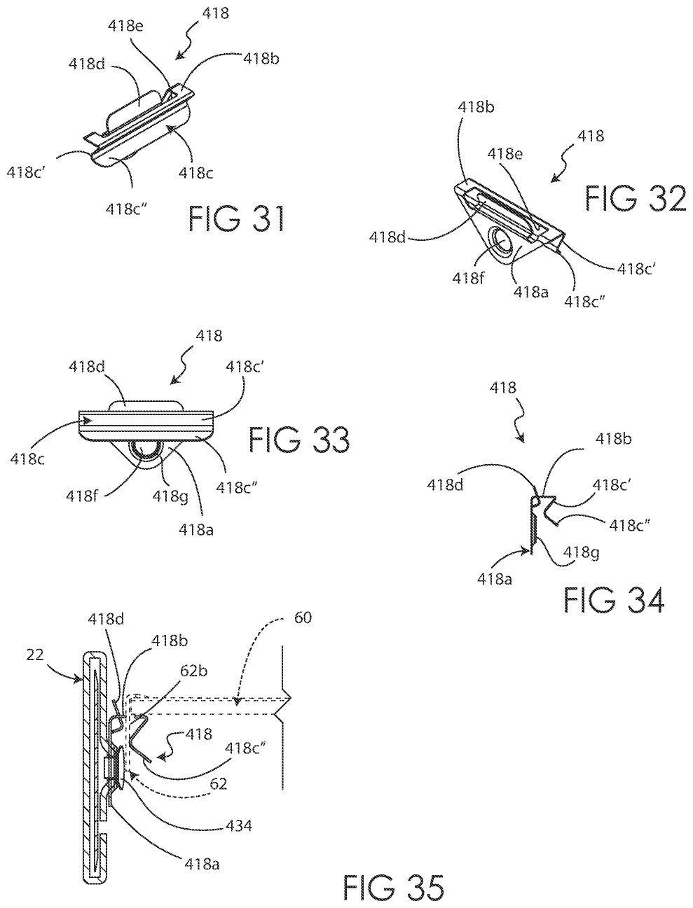

FIGS. 31-34, particularly FIG. 34, shows that tape engagement clip 418 is integrally formed from a single plate of metal that has been bent into a generally U-shaped end product. In particular tape engagement clip 418 includes a vertical first leg 418a, a horizontal second leg 418b, and a generally vertically-oriented third leg 418c that has been bent into an L-shape. In particular, the L-shaped third leg has an upper region 418c′ extending downwardly and inwardly from second leg 418b, and a lower region 418c″ extending downwardly and outwardly from upper region 418c′. The L-shaped third leg 418c extends for a distance outwardly from second housing section 22 and enables a user to readily grasp and manipulate tape engagement clip 418.

A U-shaped tab 418d is cut-out of an upper region of first leg 418a and a rearward portion of second leg 418b. The tab 418d is bent generally into an L-shape and is angled rearwardly to extend above second leg 418b and the top of first leg 418a. The cut-out region of second leg 418b defines a passage 418e in second leg 418b through which an end 62 of a measuring tape 60 may be inserted as shown in FIGS. 30 and 35.

In accordance with an aspect of the disclosure, a through-hole 418f is defined in first leg 418a. Hole 418f extends from inner surface of first leg 418a through to an outer surface thereof. A reinforcing ring 418g (FIG. 33) circumscribes hole 418f. A fastener 434 is inserted through hole 418f and into the hole 22n (FIG. 3A) to secure tape engagement clip 418 to knife 10. In particular, tape engagement clip 418 may be positioned so that the inner surface of first leg 418a is in abutting contact with either or the second side wall 22f or the first wall 22e of second housing section 22 of knife 10. Tape engaging clip418 is able to rotate about the shaft of fastener 434, i.e., about an axis that is oriented at right angles to longitudinal axis “Y’ of knife 10. The rotation of tape engaging clip418 is indicated by the arrow “G” in FIG. 30. It will be understood that utility knife 10 with tape engaging clip418 secured thereto is able to be used in the same manner as has been described earlier herein with respect to any of the knife/tape engaging clips disclosed herein.

Referring now to FIGS. 36-41, utility knife 10 is shown with a fifth embodiment tape engaging clip engaged therewith. Utility knife 10 is identical to the knife 10 illustrated and described with reference to FIGS. 1-19. The fifth embodiment tape engagement clip is indicated by the reference number 518.

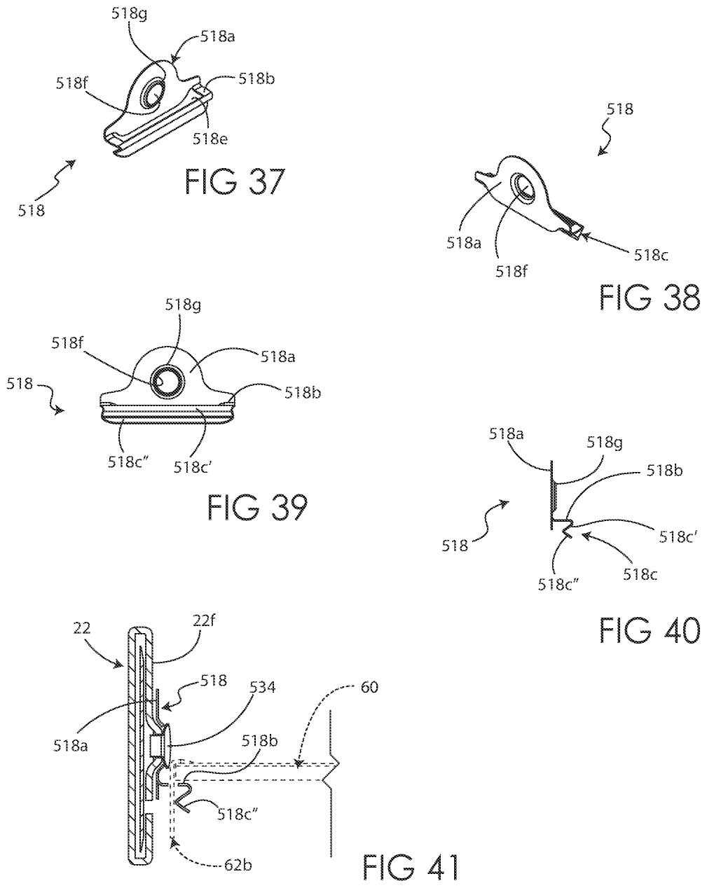

FIGS. 37-40 show that tape engagement clip 518 is integrally formed from a single plate of metal that has been bent into a generally L-shaped end product. In particular tape engagement clip 518 includes a vertical first leg 518a, a horizontal second leg 518b, and a generally vertically-oriented third leg 518c that has been bent into an L-shape. In particular, the L-shaped third leg 518c has an upper region 518c′ extending downwardly and inwardly from second leg 518b, and a lower region 518c″ extending downwardly and outwardly from upper region 518c′. The L-shaped third leg 518c extends for a distance outwardly from second housing section 22 and enables a user to readily grasp and manipulate tape engagement clip 418.

An upper edge of first leg 518a is curved to give the first leg 518a a more aesthetically pleasing appearance. The curved upper edge also defines curved corners at either end thereof. These curves help to ensure that few sharp edges are presented on tape engagement clip 518 that might accidentally injure a user during used of the tape engagement clip.

An aperture 518e is defined in of second leg 418b and defines a passage through which a vertical leg of an end 62 of a measuring tape 60 is inserted to engage a measuring tape 60 thereto as shown in FIGS. 36 and 41.

In accordance with an aspect of the disclosure, a through-hole 518f is defined in first leg 518a. Hole 518f extends from inner surface of first leg 518a through to an outer surface thereof. A reinforcing ring 518g (FIG. 33) circumscribes hole 518f. A fastener 534 is inserted through hole 518f and into the hole 22n (FIG. 3A) to secure tape engagement clip 518 to knife 10. In particular, tape engagement clip 518 may be positioned so that the inner surface of first leg 518a is in abutting contact with either or the second side wall 22f or the first wall 22e of second housing section 22 of knife 10. Tape engaging clip518 is able to rotate about the shaft of fastener 534, i.e., about an axis that is oriented at right angles to longitudinal axis “Y’ of knife 10. The rotation of tape engaging clip518 is indicated by the arrow “H” in FIG. 36. It will be understood that utility knife 10 with tape engaging clip518 secured thereto is able to be used in the same manner as has been described earlier herein with respect to any of the knife/tape engaging clips disclosed herein.

It will be understood that while it has been disclosed herein that the various tape engagement clips are able to be moved from adjacent a first side wall of the second housing section to adjacent the second side wall thereof, in other instances the user is able to simply rotate the tape engagement clip about the axis that is oriented at right angles to the longitudinal axis “Y” so that the knife 10 can be used by a left handed person or by a right handed person. The tape engagement clip can also be rotated about the axis that is oriented at right angles to longitudinal axis “Y” to change a direction in which the user able to simultaneously measure and cut with the knife.

In one aspect, a method of cutting a drywall sheet includes moving a blade member 14 longitudinally along a longitudinal axis “Y” of a utility knife housing 12 from a retracted position (where the first end 14a of blade member 14 does not extend beyond first end 22a of second housing section 22) to an extended position (where first end 14a of blade member 14 does extend outwardly beyond first end 22a of second housing section 22). The extended position is shown in FIG. 1. The method further includes providing a first cutting surface and a second cutting surface along opposed first edge 14c and second edge 14d, respectively, of blade member 14. The method further includes gripping the utility knife housing 12 in either of a first orientation or a second orientation in either of a user's left hand or right hand of the user. The first orientation, for example, may be where the palm of the user's right hand rests on first overmold 24 and the user's fingers of their right hand rest on second overmold 26. The second orientation may be where the palm of the user's right hand rests on second overmold 26 and the user's fingers of their right hand rest on first overmold 24. The first orientation and the second orientation are located 180 degrees apart and moving between the first orientation and the second orientation requires that housing 12 be rotated through 180 degrees about longitudinal axis “Y”.

The method further may include cutting a sheet of drywall with the first cutting surface of first edge 14c or with the second cutting surface of second edge 14d. The particular cutting surface utilized depends on whether housing 12 is in the first orientation or second orientation as described above.

The method further includes gripping utility knife 10 in a user's left hand or right hand by resting a palm of the user's left hand or right hand on a first overmold 24 provided on a top wall 20c of the utility knife housing 12; and resting the fingers of the user's left hand or right hand on a second overmold 26 provided on the bottom wall 20d of the utility knife housing 12. Alternatively, gripping utility knife 10 may comprise resting a palm of the user's left hand or right hand on second overmold 26 provided on bottom wall 20d of housing 12 and resting the user's finger of the user's left hand or right hand on first overmold 24 provided on top wall 20c of housing 12.

The method further includes fabricating first overmold 24 and the second overmold 26 from a resilient material. The resilient material may be rubber. The fabricating includes forming one first overmold 24 and second overmold 26 as a series of alternating ribs 24a, 26a and spaces 24b, 26b. The fabricating further comprises utilizing ribs 24a, 26a of different heights along a length of the associated first overmold 24 and the second overmold 26 and arranging the ribs 24a, 26a of different heights into a series of hills and valleys that resemble a sine wave as seen in FIG. 4. The fabricating further includes curving top wall 20c and bottom wall 20d, and positioning first overmold 24 in the curve of top wall 20c and positioning second overmold 26 in the curve of bottom wall 20d.

The fabricating further includes forming housing 12 to include a first side wall and an opposed second side wall having a midline “M” (FIG. 4) that is substantially parallel to longitudinal axis “Y”. Housing 12 is substantially symmetrical about midline “M”. The method further comprises, arranging the top wall 20c and bottom wall 20d, and the series of hills and valleys of the first overmold 24 and the second overmold 26 as mirror images of each other. The method further includes providing an inverted V-shaped projection 20j, 20k in the top wall 20c and bottom wall 20d, respectively, forwardly of each the first overmold 24 and the second overmold 26; and positioning a pad of the user's thumb 52 (FIG. 14) on a downward slope 20J′, 20K′ of one of the projection 20j, 20k, depending on whether the housing 12 of knife 10 is in the first orientation or second orientation.

The method may further include forming the utility knife housing 12 as a first housing section 20 and a second housing section 22; receiving a portion of the second housing section 22 in an interior cavity 20h defined by the first housing 20; extending a leading end of the second housing section 22 outwardly from an opening to the interior cavity 20h; and receiving the blade member 14 within an interior chamber 22h defined by second housing section 22.

In another aspect, the method may comprise positioning a free end 62 of a measuring tape 60 adjacent one of a first side wall 22e and a second side wall 22f of a leading end of the utility knife housing 12. The positioning may further include securing the free end 62 of the measuring tape 60 to the leading end of the utility knife housing 12. The securing may be temporary in that the free end of the measuring tape 60 may be disengaged from its engagement with the utility knife housing. The securing may include engaging a tape engaging clip 18 with one of the first side wall 22e and the second side wall 22f of the leading end of the utility knife housing 12. The securing may further include inserting a vertical leg 62b of the free end 62 of the measuring tape 60 into a passage 18g defined in the tape engaging clip 18. (Disengaging measuring tape 60 from knife 10 includes removing vertical leg 62b of free end 62 from the passage 18g. The method may further include extending a length of measuring tape 60 from a measuring tape housing and positioning the measuring tape housing a distance from the free end 62, and maintaining the measuring tape housing the distance away from the free end 62 while cutting the drywall sheet with one or the other of the first cutting edge and the second cutting edge.

The method may further include rotating the tape engaging clip 18 about an axis oriented at right angles to a longitudinal axis “Y” of the utility knife housing 12. The axis oriented at right angles to longitudinal axis “Y” extends along a shaft of fastener 34 that is utilized to secure tape engaging clip 18 to housing 12. The rotating of tape engaging clip 18 is undertaken when selecting to change from using a first cutting surface of the first edge 14c of the blade member 14 to using a second cutting surface of the second edge 14d of the blade member 14, and vice versa. The method further comprises rotating the utility knife housing through 180 degrees about the longitudinal axis “Y” after selecting which of the first cutting surface and the second cutting surface to utilize to cut an article such as a drywall sheet.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A blade member for a utility knife comprising:
a planar member having a first end, a second end opposed to the first end, and a longitudinal axis extending between the first and second ends;
wherein a first cutter tip and a second cutter tip are provided at the first end of the planar member;
wherein the first cutter tip and the second cutter tip are laterally spaced from one another; and
wherein the first cutter tip and the second cutter tip extend longitudinally in a same direction as one another and away from the second end of the planar member.

2. The blade member according to claim 1, wherein the first cutter tip and the second cutter tip are identical in shape.

3. The blade member according to claim 1, wherein the first cutter tip and the second cutter tip are V-shaped.

4. The blade member according to claim 1, wherein the first end of the planar member defines a U-shaped recess therein.

5. The blade member according to claim 1, wherein the first cutter tip and the second cutter tip are arranged on the blade member as mirror images of one another.

6. The blade member according to claim 1, wherein a midline of the blade member is located between the first cutter tip and the second cutter tip.

7. The blade member according to claim 1, wherein the first cutter tip and the second cutter tip are laterally separated from one another by a U-shaped recess.

8. The blade member according to claim 1, wherein the planar member further comprises:
a first side edge and an opposed second side edge that extend between the first and second ends of the blade member and define a lateral direction between them;
a first cutting surface formed on at least a portion of the first side edge of the planar member; and
a second cutting surface formed on at least a portion of the second side edge of the planar member.

9. The blade member according to claim 8, wherein the first cutting surface and the second cutting surface are arranged parallel to the longitudinal axis.

10. The blade member according to claim 8, wherein the portion of the first side edge formed into the first cutting surface, and the portion of the second side edge formed into the second cutting surface are curved.

11. The blade member according to claim 10, wherein the first cutting surface and the second cutting surface are concave in curvature.

12. The blade member according to claim 8, wherein the first cutting surface and the second cutting surface each terminate a distance inwardly from the first end of the planar member moving in a direction towards the second end of the planar member.

13. The blade member according to claim 12, wherein the planar member is comprised of a plurality of blade segments which are identical to one another, wherein adjacent blade segments are separated from one another by a line of weakness which extends from a first edge of the planar member to a second edge of the planar member.

14. The blade member according to claim 13, wherein the first cutting surface and the second cutting surface do not extend from a first line of weakness to an adjacent second line of weakness.

15. The blade member according to claim 1, wherein the planar member has a first side edge and an opposed second side edge that extend between the first and second ends of the blade member, wherein the planar member is comprised of a plurality of blade segments which are identical to one another, wherein adjacent blade segments are separated from one another by a line of weakness which extends from the first side edge to the second side edge.

16. The blade member according to claim 15, wherein a portion of the first side edge and a portion of the second side edge which is provided on each of the plurality of blade segments includes a first cutting surface and a second cutting surface, respectively; and wherein the first cutting surface and the second cutting surface extend from a first line of weakness to an adjacent second line of weakness.

17. The blade member according to claim 1, wherein the planar member is comprised of a plurality of blade segments which are identical to one another and are separated from one another by a line of weakness; and wherein each blade segment includes a leading end identical to the first end of the blade member.

18. The blade member according to claim 17, wherein each blade segment is separately removable from a rest of the planar member.

19. The blade member according to claim 1, wherein the planar member includes a first edge and a second edge extending between the first and second ends, wherein the planar member has a length measured between the first and second ends; and wherein a cutting surface is provided on each of the first and second edges and the cutting surface extends for substantially the entire length of the planar member.

20. The blade member according to claim 10, further comprising a region of the planar member located adjacent the second end thereof, wherein the region forms a blade segment of a different shape to other blade segments of the planar member, wherein the region defines an aperture therein which extends from a first surface to a second surface of the planar member, and wherein the aperture is adapted to receive a fastener therethrough to secure the blade member to a utility knife housing.
